(19) United States
(12) Patent Application Publication
(10) Pub. No.: US 2017/0032696 A1
(43) Pub. Date: Feb. 2, 2017

(54) EDUCATIONAL METHOD OF TEACHING ARITHMETIC

(71) Applicant: ALI ASHOUR AL-JAFAR, BAYAN (KW)

(72) Inventor: ALI ASHOUR AL-JAFAR, BAYAN (KW)

(21) Appl. No.: 14/811,780

(22) Filed: Jul. 28, 2015

(51) Int. Cl. G09B 19/02

(52) U.S. Cl. CPC G09B 19/02

(57) ABSTRACT

The educational method of teaching arithmetic includes instructing a student to perform the following steps: numbering the corners of a square sheet of paper in numerical sequence, preparing addition tables using only the numbers on the sheet of paper for the addends and sums, preparing multiplication tables using only the numbers on the sheet of paper for the multiplicands and products, folding the sheet of paper in a series of steps to form an origami figure, numbering each new angle formed in the sheet by fold lines by continuing the numerical sequence after each folding step in the series, forming additional addition and multiplication tables after each folding step in the series to include new sums and products made possible by the step of numbering each new angle formed by the fold lines, and continuing the folding steps and forming new tables until the origami figure is completed.

### BACKGROUND OF THE INVENTION

1. Field of the Invention

The present invention relates to teaching methods, and particularly to an educational method of teaching arithmetic using origami as a visual aid.

2. Description of the Related Art

There are a myriad of devices, programs, and techniques that can assist individuals, particularly children, in learning arithmetic. For example, there are a wide variety of teaching aids, such as flash cards and workbooks, computer programs, and computer games that can be used to assist children in not only learning arithmetic, but also improving their arithmetic skills. While these methods are generally effective, some of them may seem like a lot of work to a child, sometimes resulting in a short attention span and flagging interest, while others may be expensive and beyond the parents' means. There is a need for a pneumonic device that is simple, inexpensive, and provides a fun way of encouraging children to learn arithmetic.

Thus, an educational method of teaching arithmetic solving the aforementioned problems is desired.

### SUMMARY OF THE INVENTION

The educational method of teaching arithmetic includes the steps of instructing a student to number the corners of a square sheet of paper in numerical sequence, instructing the student to prepare addition tables using only the numbers on the sheet of paper for the addends and sums, instructing the student to perform subtraction as a reciprocal operation of addition, instructing the student to prepare multiplication tables using only the numbers on the sheet of paper for the multiplicands and products, instructing the student to perform division as a reciprocal operation of multiplication, instructing the student to fold the sheet of paper in a series of steps to form an origami figure, instructing the student to number each new angle formed in the sheet by fold lines by continuing the numerical sequence after each folding step in the series, instructing the student to form additional addition and multiplication tables after each folding step in the series to include new sums and products made possible by the step of numbering each new angle formed by the fold lines, and instructing the student to continue the folding steps and forming new tables until the origami figure is completed. A preferred origami figure is an origami crane, but other origami figures that produce a plurality of polygonal shapes defined by the fold lines may be used in the method.

These and other features of the present invention will become readily apparent upon further review of the following specification and drawings.

### BRIEF DESCRIPTION OF THE DRAWINGS

FIG. 1 is a front view of a sheet of paper that was folded into an origami crane, shown unfolded with the angles numbered, illustrating an educational method of teaching arithmetic according to the present invention.

FIGS. 1A, 1B, 1C, and 1D are detail views of the upper left, upper right, lower left, and lower right quadrants, respectively, of the sheet of paper of FIG. 1, illustrating further details thereof.

FIG. 2 is a front view of a sheet of paper, illustrating an exemplary first step in an educational method of teaching arithmetic according to the present invention.

FIG. 3 is a front view of the sheet of paper of FIG. 2, shown after executing an exemplary second step in an educational method of teaching arithmetic according to the present invention.

FIG. 4 is a front view of the sheet of paper of FIG. 2, shown after executing an exemplary third step in an educational method of teaching arithmetic according to the present invention.

FIG. 5 is a perspective view of the sheet of paper of FIG. 4, shown folded after executing an exemplary fourth step of making an origami crane in an educational method of teaching arithmetic according to the present invention.

FIG. 6A is a perspective view of the sheet of paper of FIG. 5, shown in the process of executing an exemplary fifth step of making an origami crane in an educational method of teaching arithmetic according to the present invention.

FIG. 6B is a perspective view of the sheet of paper of FIG. 6A, shown after making the same folds of FIG. 6A on the rear face of the sheet of paper in the process of executing an exemplary fifth step of making an origami crane in an educational method of teaching arithmetic according to the present invention.

FIG. 7 is a front view of the sheet of paper of FIG. 6B, shown after completion of the exemplary fifth step in an educational method of teaching arithmetic according to the present invention, the sheet being unfolded, the fold lines being shown as dotted lines, and the angles defined by the fold lines being numbered.

FIG. 8A is a front view of the sheet of paper of FIG. 7, shown after executing an exemplary intermediate fold in an exemplary sixth step of making an origami crane in an educational method of teaching arithmetic according to the present invention.

FIG. 8B is a rear view of the sheet of paper of FIG. 8A.

FIG. 8C is a perspective view of the sheet of paper of FIGS. 8A and 8B, shown partially unfolded.

FIGS. 9, 10, and 11 are perspective views of the sheet of paper of FIG. 8C, showing further intermediate folding stages in an exemplary sixth step of making an origami crane in an educational method of teaching arithmetic according to the present invention.

FIG. 12 is a front view of the sheet of paper of FIG. 11, shown after completion of the exemplary sixth step of making an origami crane in an educational method of teaching arithmetic according to the present invention, the sheet being unfolded, the fold lines being shown as dotted lines, and the angles defined by the fold lines being numbered.

FIGS. 13 and 14 are perspective views of the sheet of paper of FIG. 12, showing intermediate folding stages in an exemplary seventh step of making an origami crane in an educational method of teaching arithmetic according to the present invention.

FIG. 15 is a front view of the sheet of paper of FIG. 14, shown after completion of the exemplary seventh step of making an origami crane in an educational method of teaching arithmetic according to the present invention, the sheet being unfolded, the fold lines being shown as dotted lines, and the angles defined by the fold lines being numbered.

FIGS. 16 and 17 are perspective views of the sheet of paper of FIG. 15, showing intermediate folding stages in an exemplary eighth step of making an origami crane in an educational method of teaching arithmetic according to the present invention.

FIG. 18 is a front view of the sheet of paper of FIG. 17, shown after completion of the exemplary eighth step of making an origami crane in an educational method of teaching arithmetic according to the present invention, the sheet being unfolded, the fold lines being shown as dotted lines, and the angles defined by the fold lines being numbered.

FIGS. 19 and 20 are perspective views of the sheet of paper of FIG. 18, showing intermediate folding stages in an exemplary ninth step of making an origami crane in an educational method of teaching arithmetic according to the present invention.

FIG. 21 is a front view of the sheet of paper of FIG. 20, shown after completion of the exemplary ninth step of making an origami crane in an educational method of teaching arithmetic according to the present invention, the sheet being unfolded, showing the new fold lines in the upper left and lower right quadrants as dotted lines.

FIG. 21A is a front detail view of the upper left quadrant of FIG. 21, shown after the angles have been numbered, in an educational method of teaching arithmetic according to the present invention.

FIG. 21B is a front detail view of the lower right quadrant of FIG. 21, shown after the angles have been numbered, in an educational method of teaching arithmetic according to the present invention.

Similar reference characters denote corresponding features consistently throughout the attached drawings.

### DETAILED DESCRIPTION OF THE PREFERRED EMBODIMENTS

The educational method of teaching arithmetic includes the steps of instructing a student to number the corners of a square sheet of paper in numerical sequence, instructing the student to prepare addition tables using only the numbers on the sheet of paper for the addends and sums, instructing the student to perform subtraction as a reciprocal operation of addition, instructing the student to prepare multiplication tables using only the numbers on the sheet of paper for the multiplicands and products, instructing the student to perform division as a reciprocal operation of multiplication, instructing the student to fold the sheet of paper in a series of steps to form an origami figure, instructing the student to number each new angle formed on the sheet of paper by fold lines by continuing the numerical sequence after each folding step in the series to create a plurality of numbered angles, instructing the student to form additional addition and multiplication tables after each folding step in the series to include new sums and products made possible by the step of numbering each new angle formed by the fold lines, and instructing the student to continue the folding steps and forming new tables until the origami figure is completed.

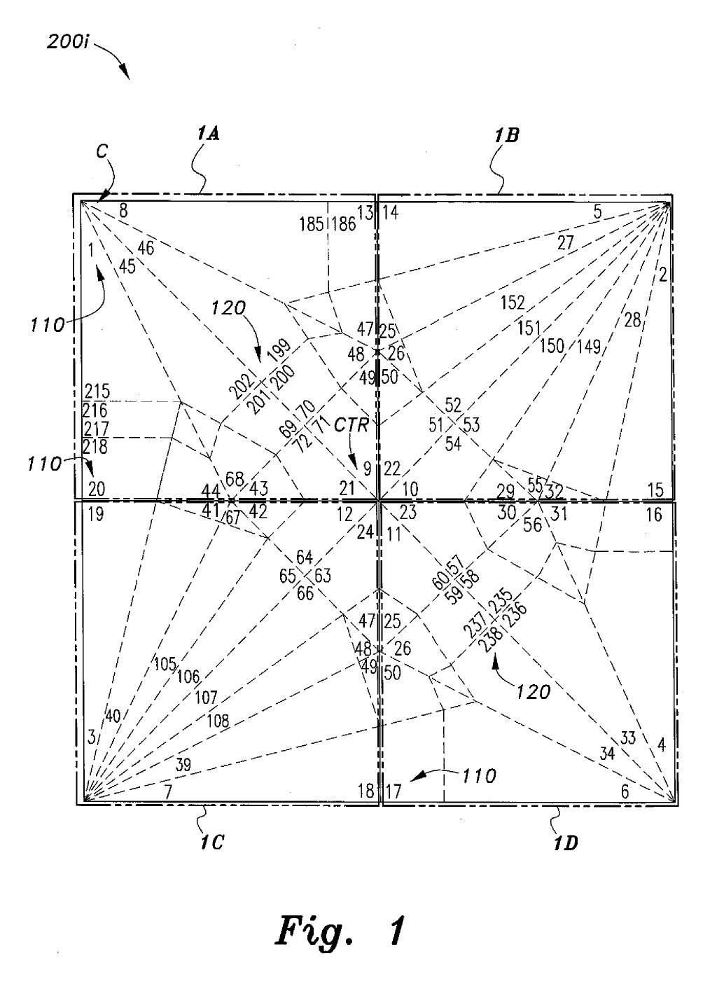

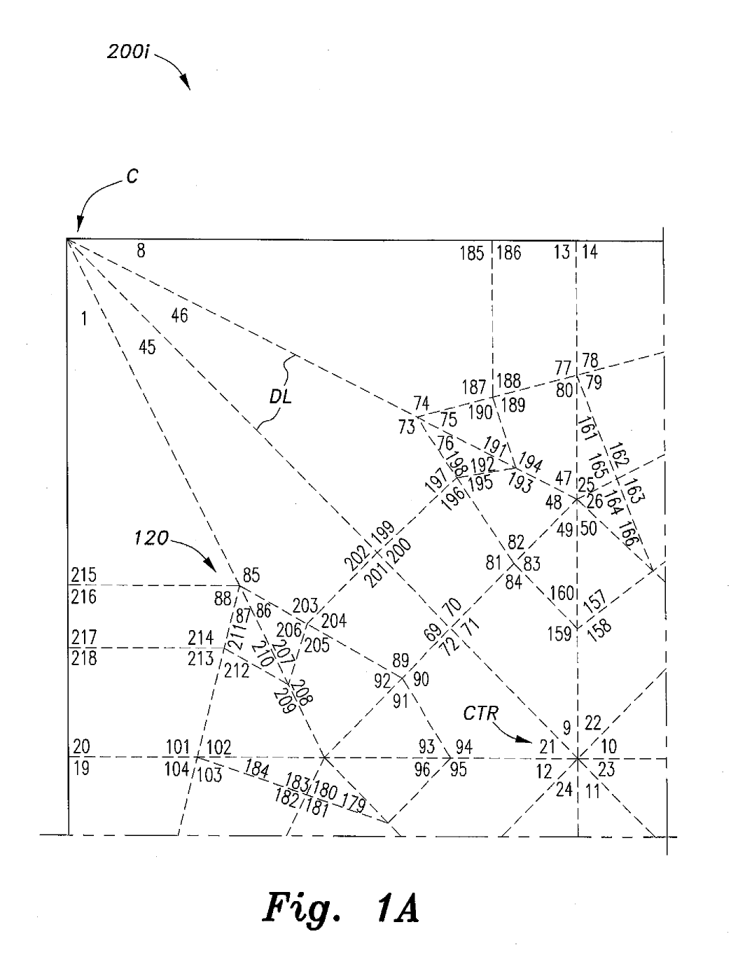

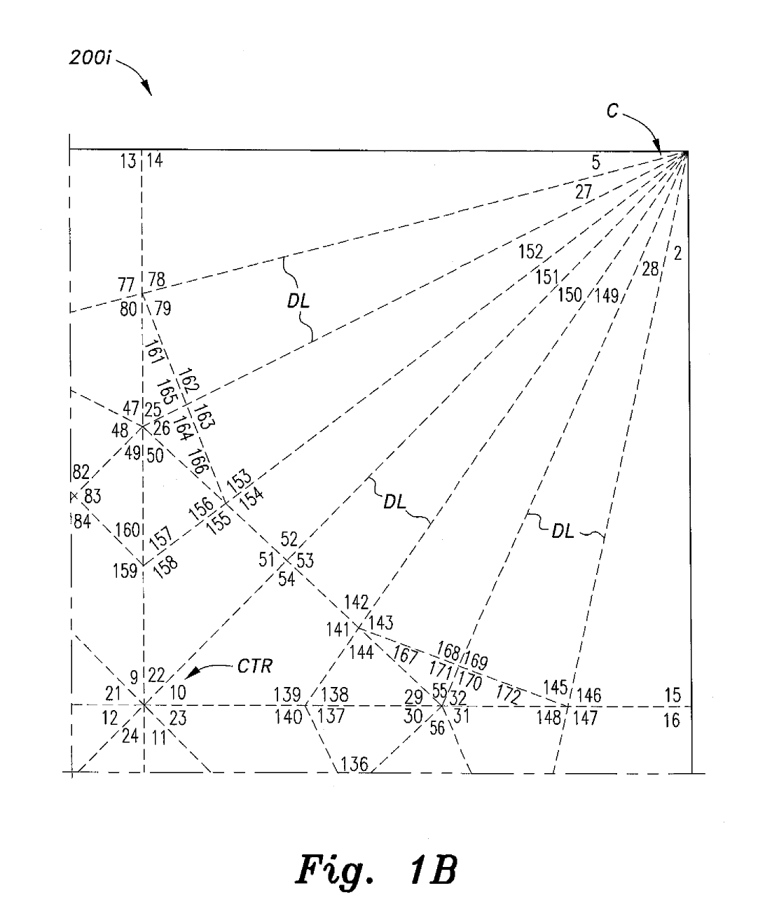

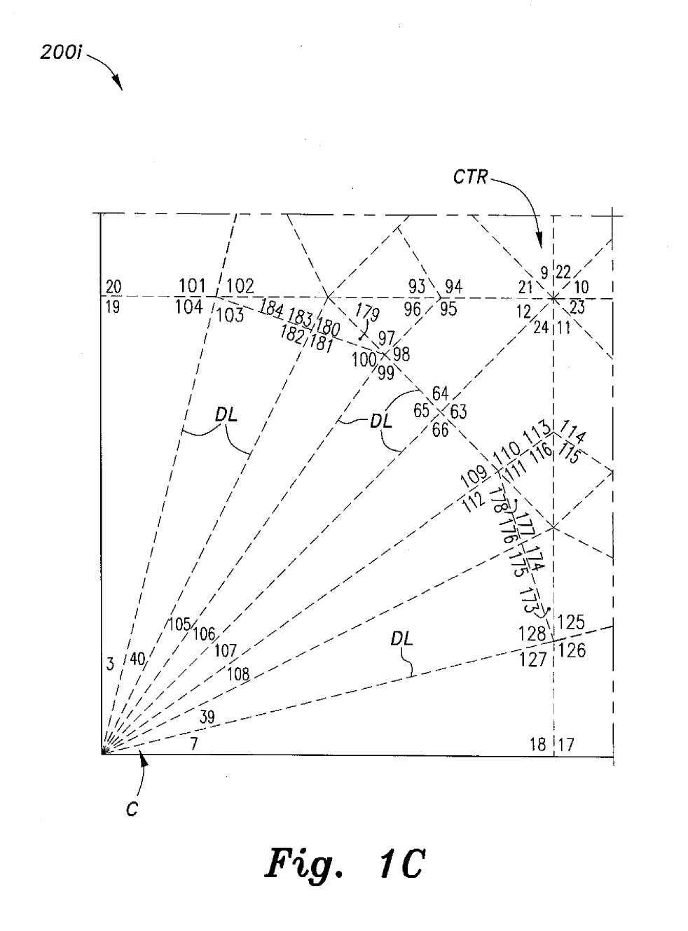

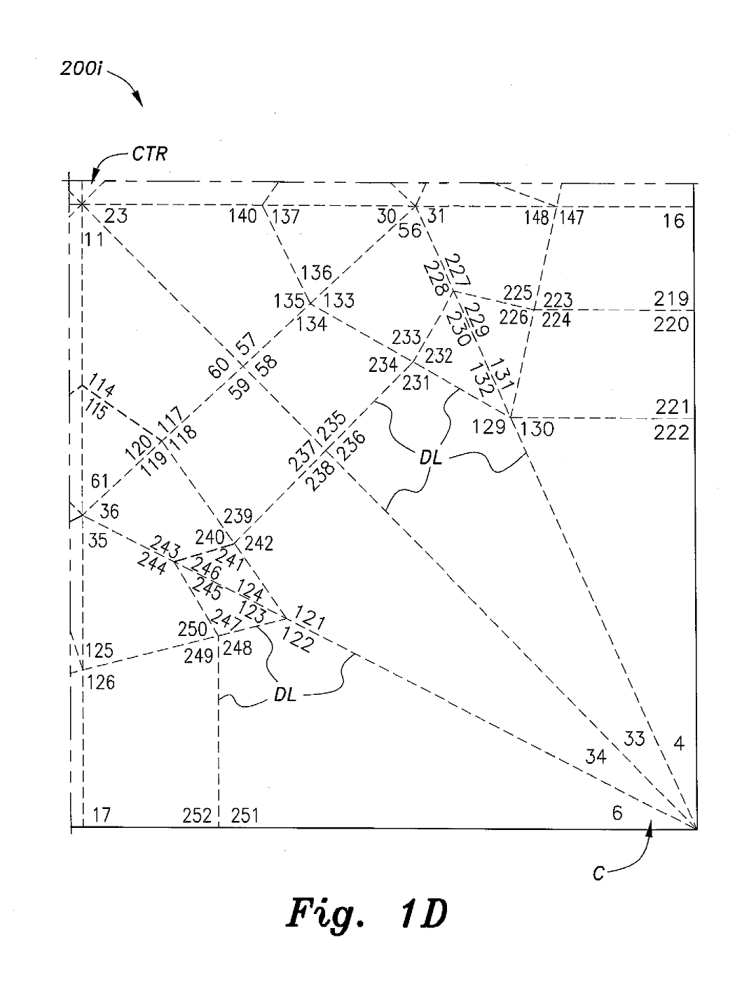

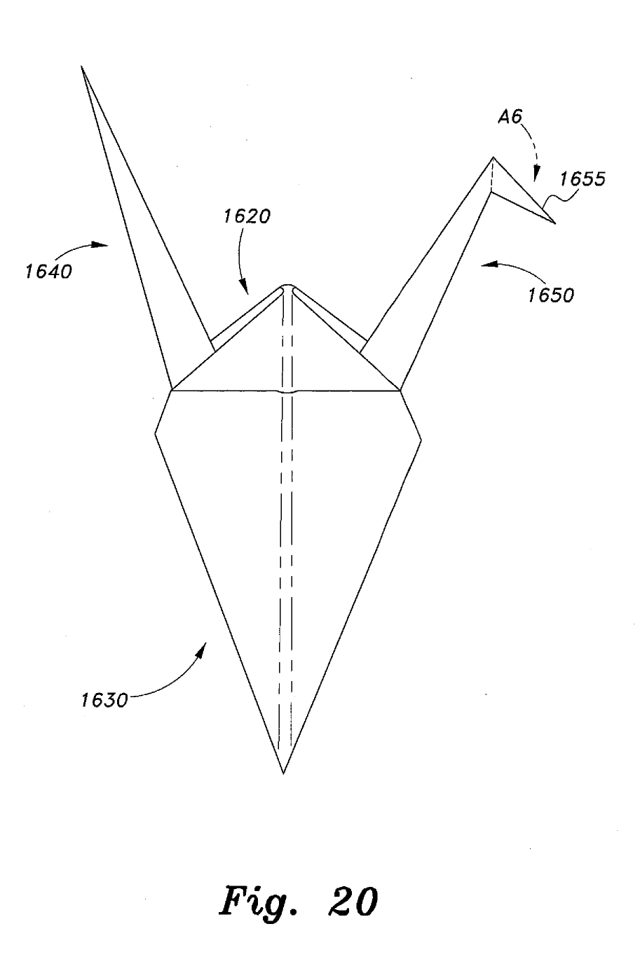

For illustration purposes only in the drawings, each of the folds is denoted by a dashed line DL, such as in FIGS. 1, 1A-1D, 3, 4, 7, 12, 15, 18, 21, 21A, and 21B. Each fold made to create the origami figure can correspond to various new angles AN on the flat sheet of paper, designated at various stages in the folding process as 200a, 200b, 200c, 200d, 200e, 200f, 200g, 200h, and 200i, respectively. It is to be noted that each of the plurality of numbered angles 110 can be located on one of the corners C and/or at an intersection 120 of fold lines, such as where at least two dashed lines DL meet. It is to be noted that a preferred origami figure is an origami crane, as illustrated in FIG. 20, but other origami figures that produce a plurality of polygonal shapes defined by the fold lines may be used in the method.

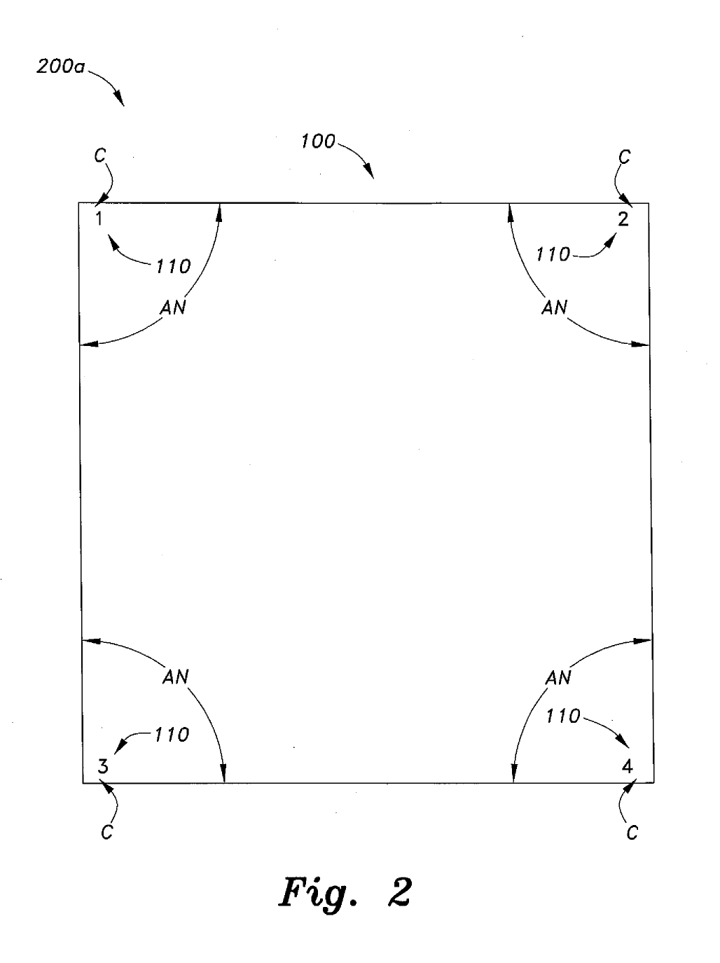

By way of operation, the first step in the series of steps in forming the origami crane includes instructing the student(s) to number each of the corners C on the square sheet of paper 100 with numbers 1 through 4 in numerical sequence, to form the first intermediate stage 200a, as illustrated in FIG. 2. It is to be noted that the student can arrange the numbers in any suitable manner, such as from right to left, from left to right, from top to bottom, or from bottom to top. Once each corner C has been numbered with the numbers 1 through 4 the student can use the numbers to create Addition Tables that can be used to learn addition and subtraction, and Multiplication Tables that can be used to learn multiplication and division.

Tables 1.1 through 1.3 illustrate addition operations and corresponding solutions, and Tables 2.1 through 2.4 illustrate multiplication operations and corresponding solutions using the numbers 1 through 4. The lowest sum, for example, is 2 (i.e., 1+1=2), and the highest sum is 4 (i.e., 3+1=4), whereas the lowest product is 1 (i.e., 1×1=1), and the highest product is 4 (i.e., 4×1=4). Subtraction is the reciprocal process of the addition operations illustrated in Tables 1.1 through 1.3, and division is the reciprocal process of the multiplication operations illustrated in Tables 2.1 through 2.4, respectively, (e.g., 3+1=4, 4−1=3) and (e.g., 4×1=1, 4/1=4).

Addition Tables

| Table 1.1 | Table 1.2 | Table 1.3 |
|---|---|---|
| 1 + 1 = 2 | 2 + 1 = 3 | 3 + 1 = 4 |
| 1 + 2 = 3 | 2 + 2 = 4 | |
| 1 + 3 = 4 | | |

Multiplication Tables

| Table 2.1 | Table 2.2 | Table 2.3 | Table 2.4 |
|---|---|---|---|
| 1 × 1 = 1 | 2 × 1 = 2 | 3 × 1 = 3 | 4 × 1 = 4 |
| 1 × 2 = 2 | 2 × 2 = 4 | | |
| 1 × 3 = 3 | | | |

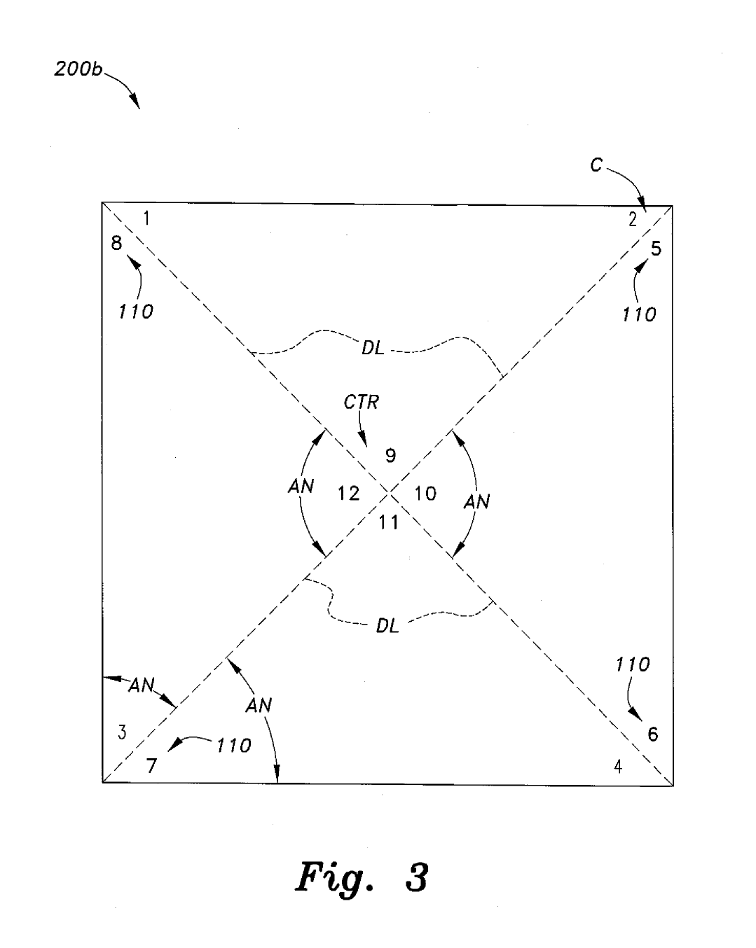

The second step in the series of steps in forming the origami crane 500i includes instructing the student(s) to fold the first flat sheet 200a in half in a diagonal direction to create two folds. For example, the student folds the corner C of the first intermediate stage 200a having the number (1) until it meets the corner C of the first intermediate stage 200a having the number (4), and folds the opposite corners in a similar fashion to create two diagonal folds, denoted by the dashed lines DL crossing each other at the center CTR. The student then number each new angle AN that is formed, including the angles formed at the center CTR, with the numbers 5 through 12 in numerical sequence, to form the second intermediate stage 200b, as illustrated in FIG. 3. Once each new angle AN has been numbered with the numbers 5 through 12 the student(s) use the numbers to create tables, such as Tables 1.4 through 1.11, that can be used to learn additional addition and subtraction operations, and other tables, such as Tables 2.5 through 2.12, that can be used to learn additional multiplication and division operations.

Tables 1.4 through 1.11 illustrate the addition operations and corresponding solutions, and Tables 2.5 through 2.12 illustrate the multiplication operations and corresponding solutions using the numbers 5 through 12. The lowest sum is 6 (i.e., 5+1=6), and the highest sum is 12 (i.e., 11+1=12), whereas the lowest product is 5 (i.e., 5×1=5), and the highest product is 12 (i.e., 12×1=12). Subtraction is the reciprocal process of the addition operations illustrated in Tables 1.4 through 1.11, and division is the reciprocal process of the multiplication operations illustrated in Tables 2.5 through 2.12, respectively.

Addition Tables (cont'd)

| Table | Table | Table | Table | Table | Table | Table |
|---|---|---|---|---|---|---|
| 1.4 | 1.5 | 1.6 | 1.7 | 1.8 | 1.9 | 1.10 |
| 5 + 1 = 6 | 6 + 1 = 7 | 7 + 1 = 8 | 8 + 1 = 9 | 9 + 1 = 10 | 10 + 1 = 11 | 11 + 1 = 12 |
| 5 + 7 = 12 | 6 + 6 = 12 | 7 + 5 = 12 | 8 + 4 = 12 | 9 + 3 = 12 | 10 + 2 = 12 | |

Multiplication Tables (cont'd)

| Table | Table | Table | Table | Table | Table | Table | Table |
|---|---|---|---|---|---|---|---|
| 2.5 | 2.6 | 2.7 | 2.8 | 2.9 | 2.10 | 2.11 | 2.12 |
| 5 × 1 = 5 | 6 × 1 = 6 | 7 × 1 = 7 | 8 × 1 = 8 | 9 × 1 = 9 | 10 × 1 = 10 | 11 × 1 = 11 | 12 × 1 = 12 |
| 5 × 2 = 10 | 6 × 2 = 12 | | | | | | |

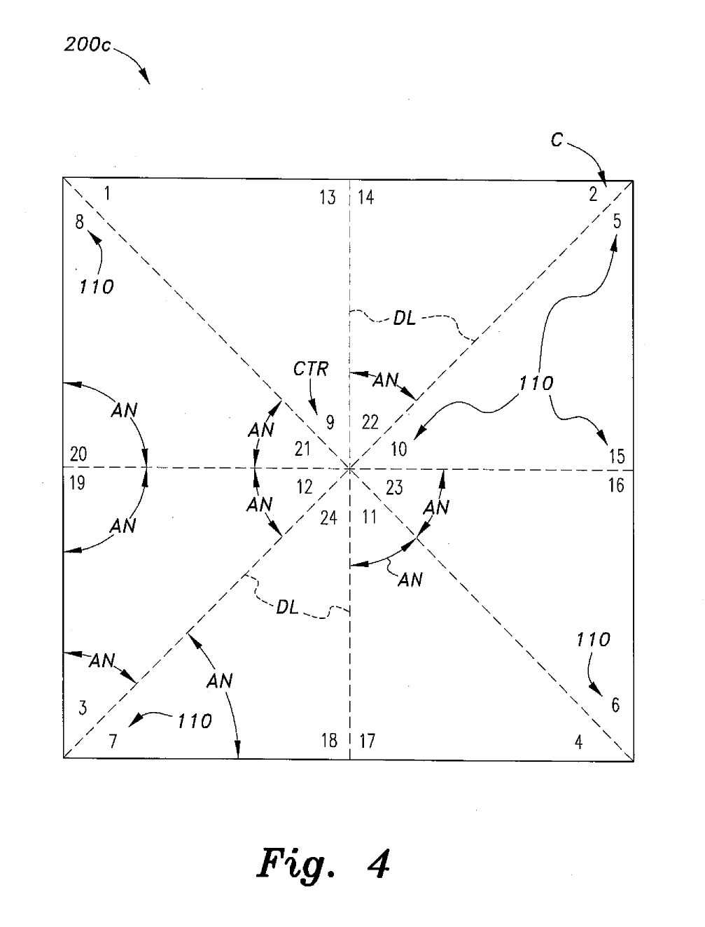

The third step in the series of steps in forming the origami crane includes instructing the student(s) to fold the second intermediate stage 200b in half in horizontal and vertical directions to create two additional folds, a horizontal fold and a vertical fold. For example, the student folds the second intermediate stage 200b such that the corner C of the second intermediate stage 200b having the number (8) meets the corner C of the second intermediate stage 200b having the number (7), and folds the opposite corners in a similar fashion to create a horizontal fold and a vertical fold denoted by the dashed lines DL crossing each other at the center CTR. The student then numbers each new angle AN with the numbers 13 through 24 in numerical sequence to form the third intermediate stage 200c, as illustrated in FIG. 4. Once each new angle AN has been numbered with the numbers 13 through 24 in numerical sequence the student(s) can use the numbers to create tables, such as Tables 5, that can be used to learn addition and subtraction, and other tables, such as Tables 6, that can be used to learn multiplication and division.

Table 5 illustrates the addition operations and corresponding solutions and Table 6 illustrates the multiplication operations and corresponding solutions using the numbers 13 through 24. The lowest sum is 14 (i.e., 13+1=14), and the highest sum is 24 (i.e., 23+1=24), whereas the lowest product is 13 (i.e., 13×1=13) and the highest product is 24 (i.e., 12×2=24). Subtraction is the reciprocal process of the addition operations illustrated in Table 5, and division is the reciprocal process of the multiplication operations illustrated in Table 6, respectively.

Addition Tables (cont'd)

| Table | Table | Table | Table | Table | Table | Table |
|---|---|---|---|---|---|---|
| 1.13 | 1.14 | 1.15 | 1.16 | 1.17 | 1.18 | 1.19 |
| 13 + 1 = 14 | 14 + 1 = 15 | 15 + 1 = 16 | 16 + 1 = 17 | 17 + 1 = 18 | 18 + 1 = 19 | 19 + 1 = 20 |
| 13 + 11 = 24 | 14 + 10 = 24 | 15 + 9 = 24 | 16 + 8 = 24 | 17 + 7 = 24 | 18 + 6 = 24 | 19 + 5 = 24 |

| Table | Table | Table | Table | Table |
|---|---|---|---|---|
| 1.20 | 1.21 | 1.22 | 1.23 | 1.24 |
| 20 + 1 = 21 | 21 + 1 = 22 | 22 + 1 = 23 | 22 + 1 = 23 | 23 + 1 = 24 |
| 20 + 4 = 24 | 21 + 3 = 24 | 22 + 2 = 24 | | |

Multiplication Tables (cont'd)

| Table | Table | Table | Table | Table | Table | Table | Table |
|---|---|---|---|---|---|---|---|
| 2.1 | 2.2 | 2.3 | 2.4 | 2.5 | 2.6 | 2.7 | 2.8 |
| 1 × 13 = 13 | 2 × 3 = 6 | 3 × 2 = 6 | 4 × 2 = 8 | 5 × 1 = 5 | 6 × 1 = 6 | 7 × 1 = 7 | 8 × 1 = 8 |
| 1 × 14 = 14 | 2 × 4 = 8 | 3 × 3 = 9 | 4 × 3 = 12 | 5 × 2 = 10 | 6 × 2 = 16 | 7 × 2 = 14 | 8 × 2 = 16 |
| 1 × 15 = 15 | 2 × 5 = 10 | 3 × 4 = 12 | 4 × 4 = 16 | 5 × 3 = 15 | 6 × 3 = 18 | 7 × 3 = 21 | 8 × 3 = 24 |

| Table | Table | Table | Table |
|---|---|---|---|
| 2.9 | 2.10 | 2.11 | 2.12 |
| 9 × 1 = 9 | 10 × 1 = 10 | 11 × 1 = 11 | 12 × 1 = 12 |
| 9 × 2 = 18 | 10 × 2 = 20 | 11 × 2 = 22 | 12 × 2 = 24 |

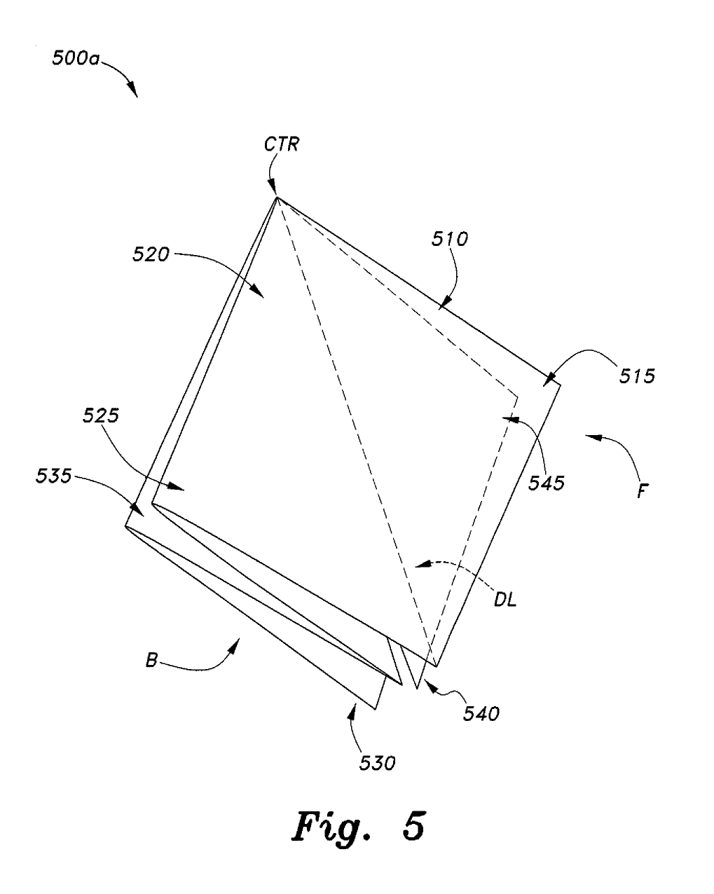

The fourth step in the series of steps in forming the origami crane includes instructing the student(s) to fold the third intermediate stage 200c so that the corners C of the third intermediate stage 200c having the numbers (1), (2), (3), and (4) can meet at one point, forming a square equal to approximately a quarter of the size of the sheet of paper 100, as illustrated in FIG. 2. For example, the student can fold the corner C having the number (1) inward and onto the corner C having the number (3), the student can then fold the corner C having the number (4) inward onto the corner C having the number (3), and then the student can fold the corner C having the number (2) downward onto the corner C having the number (3), to obtain the configuration illustrated in FIG. 5.

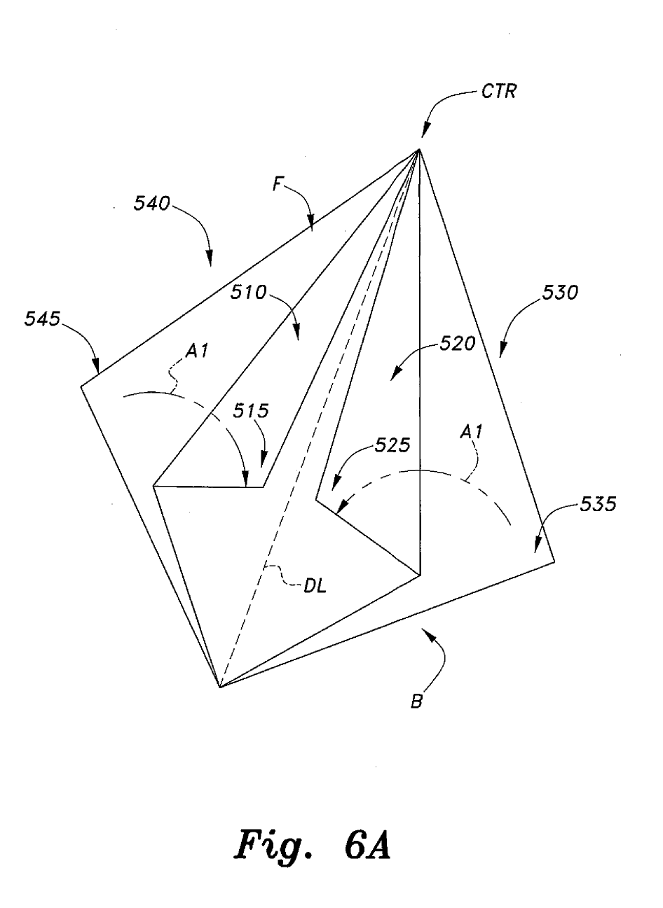

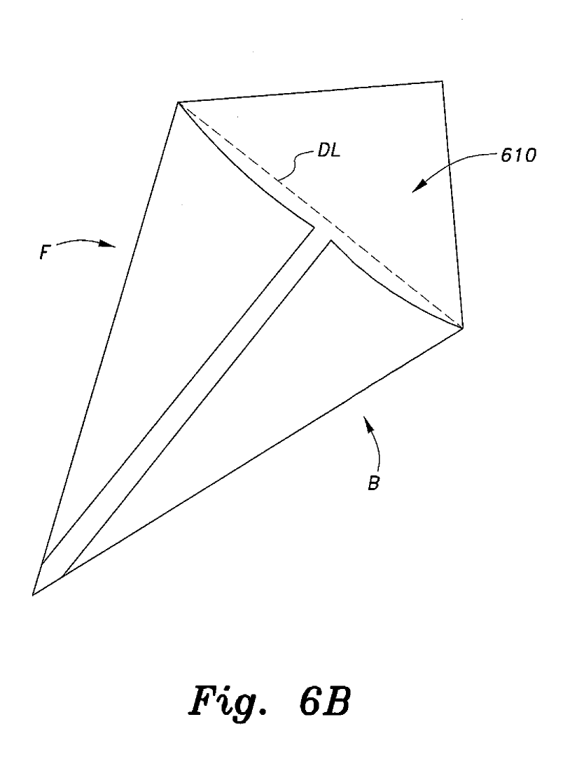

Referring to FIGS. 5 and 6A, the folded sheet has a front portion F, such as a portion facing the student, and a back portion B, such as a portion facing away from the student. The dashed line DL divides the front portion F of the first figure 500a into a first triangle 510 and a second triangle 520, as illustrated in FIGS. 5 and 6A. It is to be noted that the back portion B is divided into a third triangle 530 and a fourth triangle 540 in a similar fashion.

The first triangle 510 and the second triangle 520 on the front portion F of the first figure 500a are two equal triangles, as illustrated in FIG. 5, and the third triangle 530 and the fourth triangle 540 on the back portion B of the first figure 500a are also two equal triangles. Further, the first triangle 510 has a first tip 515, the second triangle 520 has a second tip 525, the third triangle has a third tip 535, and the fourth triangle 540 has a fourth tip 545.

The fifth step in the series of steps in forming the origami crane includes folding both the first tip 515 and the second tip 525 inward toward and along the fold denoted by the dashed line DL, as illustrated by the first arrows A1 on FIG. 6A. Then, the student flips the second figure over and folds the third tip 535 of the third triangle 530 and the fourth tip 545 of the fourth triangle 540 on the back portion B of the first figure 500a in a similar fashion along the dotted diameter line DL to obtain the configuration illustrated in FIG. 6B. It is to be noted that any folds made to the front portion F can also be made to the back portion B in the following steps. This can be referred to as the principle of “juxtaposition.” The configuration of FIG. 6B has a triangle 610, shown as the small, upper triangle 610 in FIG. 6B.

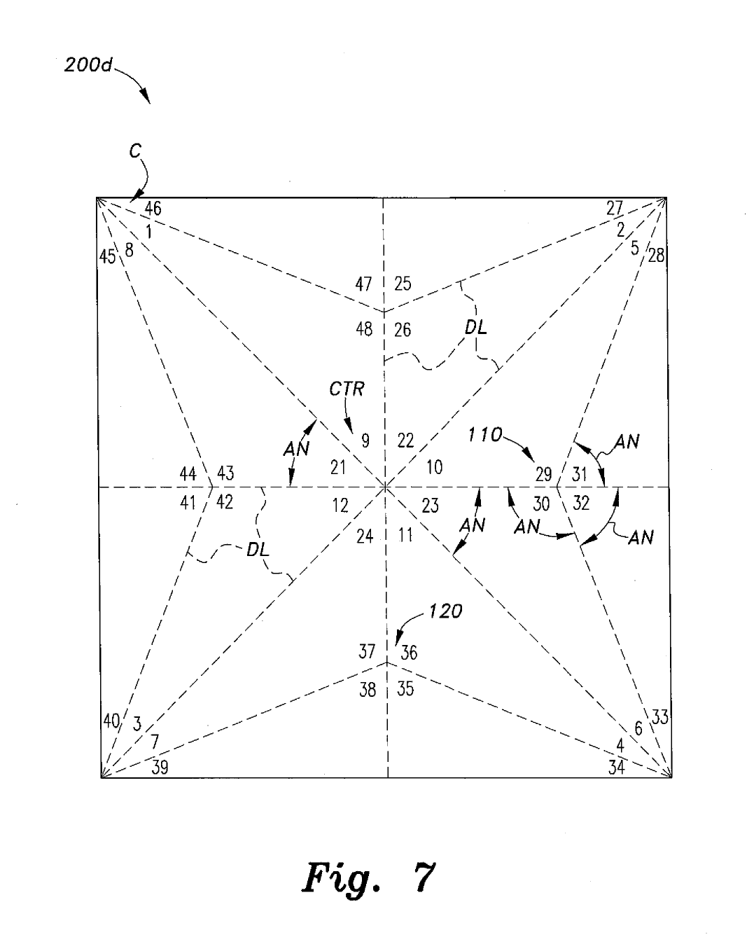

The student then unfolds the sheet of paper 100 and numbers each of the additional new angles AN with the numbers 25 through 48 in numerical sequence to form the fourth intermediate stage 200d, illustrated in FIG. 7. It is to be noted that after the folds, the fourth intermediate stage 200d has eight individual triangles. Once each new angle AN has been numbered with the numbers 25 through 48, the student(s) uses the numbers to create tables, such as Tables 1.25 through 1.47, to learn addition and subtraction operations, and other tables, such as Tables 2.1 through 2.24, to learn multiplication and division operations.

Tables 1.25 through 1.47 illustrate the addition operations and corresponding solutions and Tables 2.1 through 2.24 illustrate the multiplication operations and corresponding solutions using the numbers 25 through 48. The lowest sum is 26 (i.e., 25+1=26) and the highest sum is 48 (i.e., 47+1=48), whereas the lowest product is 25 (i.e., 25×1=25) and the highest product is 48 (i.e., 24×2=48). Subtraction is the reciprocal process of the addition operations illustrated in Tables 1.25 through 1.47, and division is the reciprocal process of the multiplication operations illustrated in Tables 2.1 through 2.24, respectively.

Addition Tables (cont'd)

| Table | Table | Table | Table | Table | Table |
|---|---|---|---|---|---|
| 1.25 | 1.26 | 1.27 | 1.28 | 1.29 | 1.30 |
| 25 + 1 = 26 | 26 + 1 = 27 | 27 + 1 = 28 | 28 + 1 = 29 | 29 + 1 = 30 | 30 + 1 = 31 |
| 25 + 23 = 48 | 26 + 22 = 48 | 27 + 21 = 48 | 28 + 20 = 48 | 29 + 19 = 48 | 30 + 18 = 48 |
| Table | Table | Table | Table | Table | Table |
| 1.31 | 1.32 | 1.33 | 1.34 | 1.35 | 1.36 |
| 31 + 1 = 32 | 32 + 1 = 33 | 33 + 1 = 35 | 34 + 1 = 29 | 35 + 1 = 36 | 36 + 1 = 37 |
| 31 + 17 = 48 | 32 + 16 = 48 | 33 + 15 = 48 | 34 + 14 = 48 | 35 + 13 = 48 | 36 + 12 = 48 |
| Table | Table | Table | Table | Table | Table |
| 1.37 | 1.38 | 1.39 | 1.40 | 1.41 | 1.42 |
| 37 + 1 = 38 | 38 + 1 = 39 | 39 + 1 = 40 | 40 + 1 = 41 | 41 + 1 = 42 | 42 + 1 = 43 |
| 37 + 11 = 48 | 38 + 10 = 48 | 39 + 9 = 48 | 40 + 8 = 48 | 41 + 7 = 48 | 42 + 6 = 48 |

| Table 1.43 | Table 1.44 | Table 1.45 | Table 1.46 | Table 1.47 |
|---|---|---|---|---|
| 43 + 1 = 44 | 44 + 1 = 45 | 45 + 1 = 46 | 46 + 1 = 47 | 47 + 1 = 48 |
| 43 + 5 = 48 | 44 + 4 = 48 | 45 + 3 = 48 | 46 + 2 = 48 | |

Multiplication Tables (cont'd)

| Table 2.1 | Table 2.2 | Table 2.3 | Table 2.4 | Table 2.5 | Table 2.6 |
|---|---|---|---|---|---|
| 1 × 25 = 25 | 2 × 13 = 26 | 3 × 9 = 27 | 4 × 7 = 28 | 5 × 5 = 25 | 6 × 5 = 30 |
| 1 × 26 = 26 | 2 × 14 = 28 | 3 × 10 = 30 | 4 × 8 = 32 | 5 × 6 = 30 | 6 × 6 = 36 |
| 1 × 48 = 48 | 2 × 24 = 48 | 3 × 16 = 48 | 4 × 12 = 48 | 5 × 9 = 45 | 6 × 8 = 48 |
| Table | Table | Table | Table | Table | Table |
| 2.7 | 2.8 | 2.9 | 2.10 | 2.11 | 2.12 |
| 7 × 4 = 28 | 8 × 4 = 32 | 9 × 3 = 27 | 10 × 3 = 30 | 11 × 3 = 33 | 12 × 3 = 36 |
| 7 × 5 = 35 | 8 × 5 = 40 | 9 × 4 = 36 | 10 × 4 = 40 | 11 × 4 = 44 | 12 × 4 = 48 |
| 7 × 6 = 42 | 8 × 6 = 48 | 9 × 5 = 45 | | | |
| Table | Table | Table | Table | Table | Table |
| 2.13 | 2.14 | 2.15 | 2.16 | 2.17 | 2.18 |
| 13 × 2 = 26 | 14 × 2 = 28 | 15 × 2 = 30 | 16 × 2 = 32 | 17 × 2 = 2.4 | 18 × 2 = 36 |
| 13 × 3 = 39 | 14 × 3 = 42 | 15 × 3 = 45 | 16 × 4 = 48 | | |
| Table | Table | Table | Table | Table | Table |
| 2.19 | 2.20 | 2.21 | 2.22 | 2.23 | 2.24 |
| 19 × 2 = 38 | 20 × 2 = 40 | 21 × 2 = 42 | 22 × 2 = 44 | 23 × 2 = 46 | 24 × 2 = 48 |

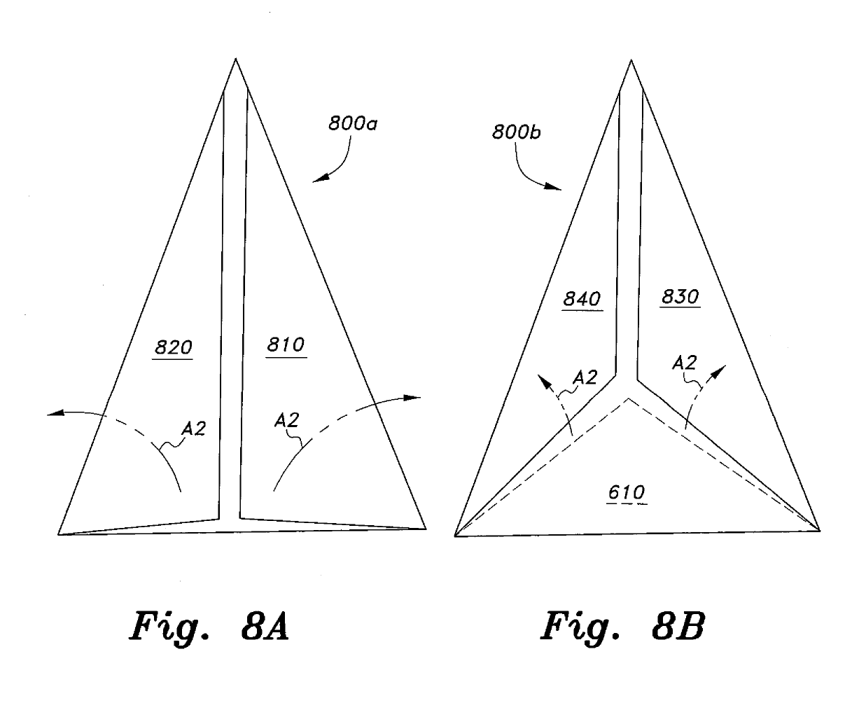

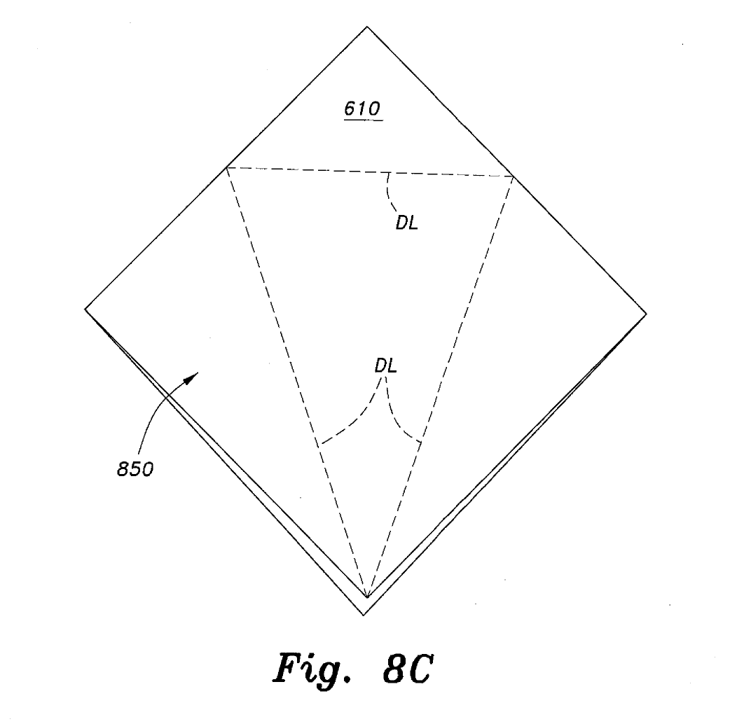

The sixth step in the series of steps in forming the origami crane includes folding the triangle 610 in the configuration of FIG. 6B in a backward direction along the dash line DL to obtain the configuration shown in FIG. 8A having a front side 800a, such as the side facing the student, and a back side 800b, such as the side facing away from the student. It is to be noted that the front side 800a of the configuration shown in FIG. 8A has a first right flap 810 and a first left flap 820. It is to be noted that the back side 800b has a second right flap 830 and a second left flap 840, as illustrated in FIG. 8B, similar to the first right flap 810 and the first left flap 820 of the front side 800a of the configuration illustrated in FIG. 8A.

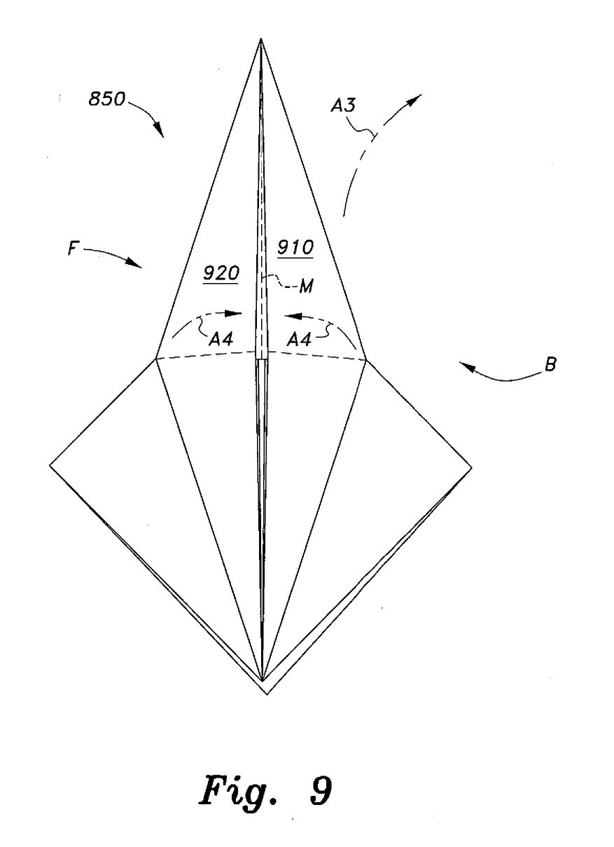

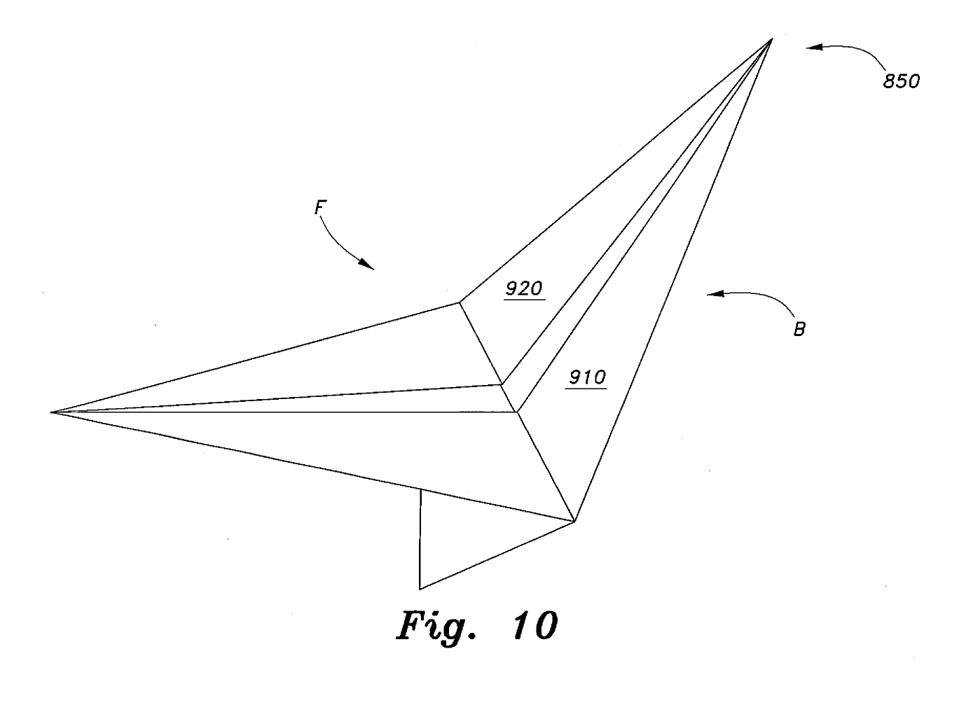

After the first right flap 810, the first left flap 820, the second right flap 830, and the second left flap 840 have been formed, the student unfolds the front face (FIG. 8A) and the back face (FIG. 8B) by unfolding the first right flap 810 and the first left flap 820 of the front side 800a and the second right flap 830 and the second left flap 840 to the right side and to the left side, respectively, as illustrated by the second arrows A2 in FIG. 8A, to obtain the configuration shown in FIG. 8C, which has an upper portion 850 and a lower portion (not shown). The dashed lines DL denote the creases formed after unfolding the first right flap 810, the first left flap 820, the second right flap 830, and the second left flap 840. The student then pulls the upper portion 850 in an upward direction, as illustrated by the third arrow A3 (shown in FIG. 9).

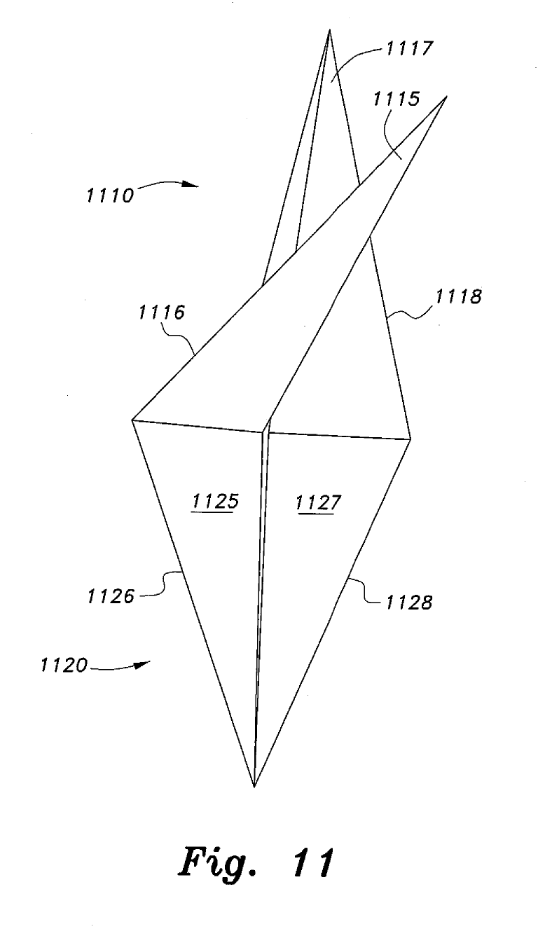

It is to be noted that as the student pulls upward on the upper portion 850, the outer flaps, such as a first lateral side 910 and a second lateral side 920, begin to fold inward toward the middle M, as illustrated by the fourth arrows A4, and by pressing from behind, the student forces the top portion 850 to lay flat to obtain the configuration illustrated in FIG. 9, which has the shape of a boat. The student can then unfold the back side in a similar fashion. It is to be noted that the lateral sides 910, 920 can be flattened after the upper portion 850 has been lifted to obtain the configuration illustrated in FIG. 10. The same folds are made to the back portion B to obtain the configuration illustrated in FIG. 11.

The configuration illustrated in FIG. 11 has a first top portion 1110, including a fifth triangle 1115 having a first outer edge 1116 and a sixth triangle 1117 having a second outer edge 1118, and a first bottom portion 1120 including a seventh triangle 1125 having a third outer edge 1126 and an eighth triangle 1127 having a fourth outer edge 1128, as illustrated in FIG. 11. It is to be noted that the fifth triangle 1115 and the sixth triangle 1117 on the first top portion 1110 are separated and the seventh triangle 1125 and the eighth triangle 1127 of the first bottom portion 1120 are connected.

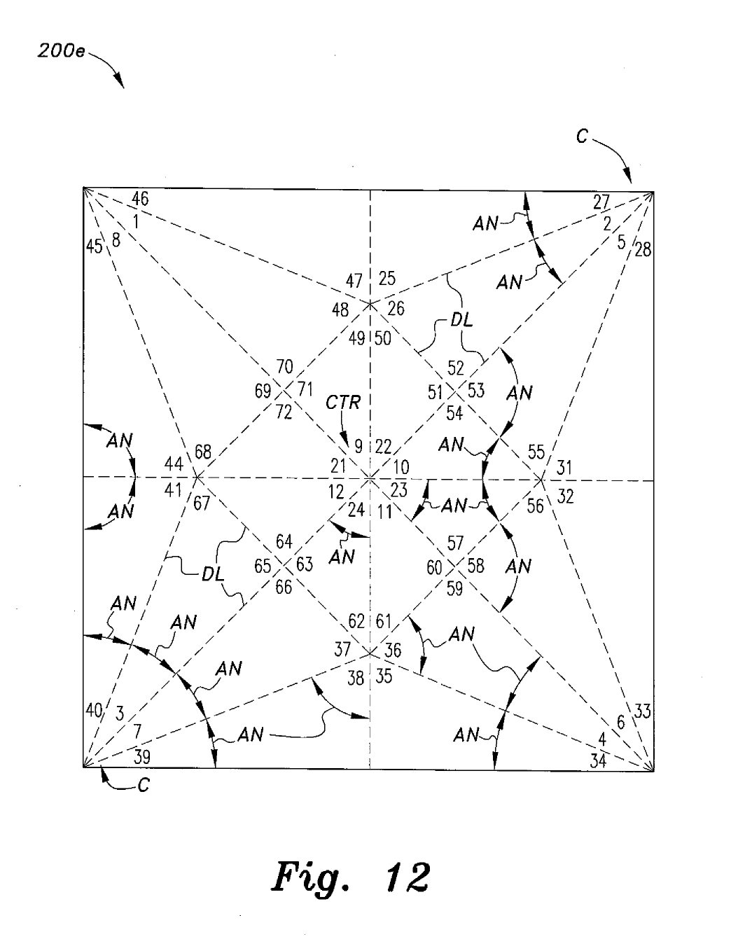

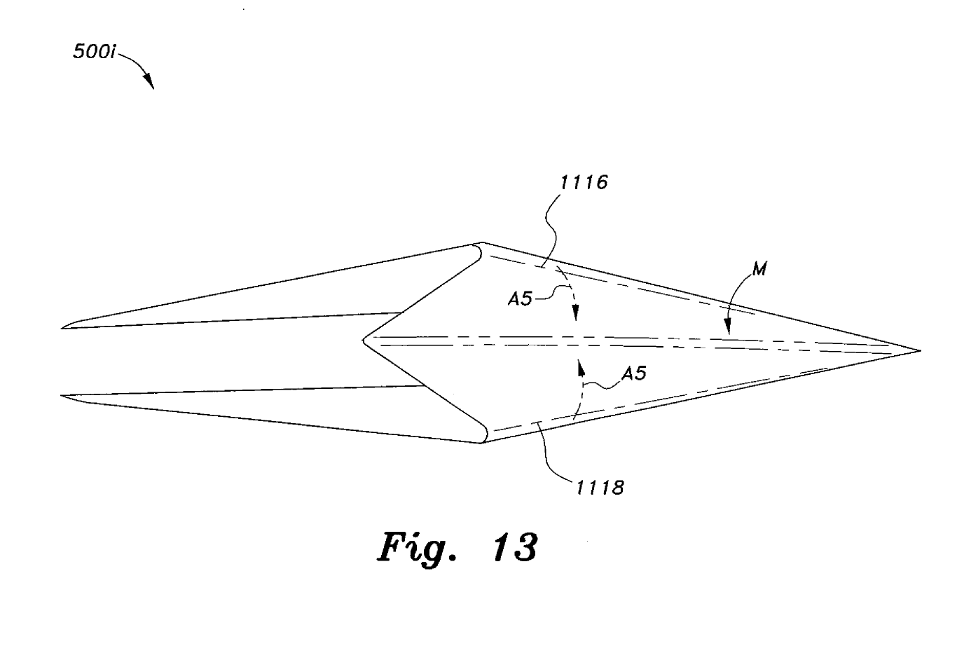

The student then unfolds the configuration of FIG. 11 and numbers each of the additional new angles AN with the numbers 49 through 72 in numerical sequence to form the fifth intermediate stage 200e, as illustrated in FIG. 12. Once each new angle AN has been numbered with the numbers 49 through 72 the student(s) uses the numbers to create tables, such as Tables 1.49 through 1.71, to learn addition and subtraction operations, and other tables, such as Tables 2.25 through 2.36, to learn multiplication and division.

Tables 1.49 through 1.71 illustrate the addition operations and corresponding solutions, and Tables 2.25 through 2.36 illustrate the multiplication operations and corresponding solutions using the numbers 49 through 72. The lowest sum is 50 (i.e., 49+1=50) and the highest sum is 72 (i.e., 71+1=72), whereas the lowest product is 25 (i.e., 25×1=25) and the highest product is 72 (i.e., 36×2=72). Subtraction is the reciprocal process of the addition operations illustrated in Tables 1.49 through 1.71, and division is the reciprocal process of the multiplication operations illustrated in Tables 2.25 through 2.36, respectively.

Addition Tables (cont'd)

| Table | Table | Table | Table | Table | Table |
|---|---|---|---|---|---|
| 1.49 | 1.50 | 1.51 | 1.52 | 1.53 | 1.54 |
| 49 + 1 = 50 | 50 + 1 = 51 | 51 + 1 = 52 | 52 + 1 = 53 | 53 + 1 = 54 | 54 + 1 = 55 |
| 49 + 23 = 72 | 50 + 22 = 72 | 51 + 21 = 72 | 52 + 20 = 72 | 53 + 19 = 72 | 54 + 18 = 72 |
| Table | Table | Table | Table | Table | Table |
| 1.55 | 1.56 | 1.57 | 1.58 | 1.59 | 1.60 |
| 55 + 1 = 56 | 56 + 1 = 57 | 57 + 1 = 58 | 58 + 1 = 59 | 59 + 1 = 60 | 60 + 1 = 61 |
| 55 + 17 = 72 | 56 + 16 = 72 | 57 + 15 = 72 | 58 + 14 = 72 | 59 + 13 = 72 | 60 + 12 = 72 |
| Table | Table | Table | Table | Table | Table |
| 1.61 | 1.62 | 1.63 | 1.64 | 1.65 | 1.66 |
| 60 + 1 = 62 | 62 + 1 = 63 | 63 + 1 = 64 | 64 + 1 = 65 | 65 + 1 = 66 | 66 + 1 = 67 |
| 61 + 11 = 72 | 62 + 10 = 72 | 63 + 9 = 72 | 64 + 8 = 72 | 65 + 7 = 72 | 66 + 6 = 72 |

| Table 1.67 | Table 1.68 | Table 1.69 | Table 1.70 | Table 1.71 |
|---|---|---|---|---|
| 67 = 1 = 68 | 68 + 1 = 69 | 69 + 1 = 70 | 70 + 1 = 71 | 71 + 1 = 72 |
| 67 + 5 = 72 | 68 + 4 = 72 | 69 + 3 = 72 | 70 + 2 = 72 | |

Multiplication Tables (cont'd)

| Table | Table | Table | Table | Table | Table |
|---|---|---|---|---|---|
| 2.25 | 2.26 | 2.27 | 2.28 | 2.29 | 2.30 |
| 25 × 1 = 25 | 26 × 1 = 26 | 27 × 1 = 27 | 28 × 1 = 28 | 29 × 1 = 29 | 30 × 1 = 30 |
| 25 × 2 = 50 | 26 × 2 = 52 | 27 × 2 = 54 | 28 × 2 = 56 | 29 × 2 = 58 | 30 × 2 = 60 |
| Table | Table | Table | Table | Table | Table |
| 2.31 | 2.32 | 2.33 | 2.34 | 2.35 | 2.36 |
| 31 × 1 = 31 | 32 × 1 = 32 | 33 × 1 = 33 | 34 × 1 = 34 | 35 × 1 = 35 | 36 × 1 = 36 |
| 31 × 2 = 62 | 32 × 2 = 64 | 33 × 2 = 66 | 34 × 2 = 68 | 35 × 2 = 70 | 36 × 2 = 72 |

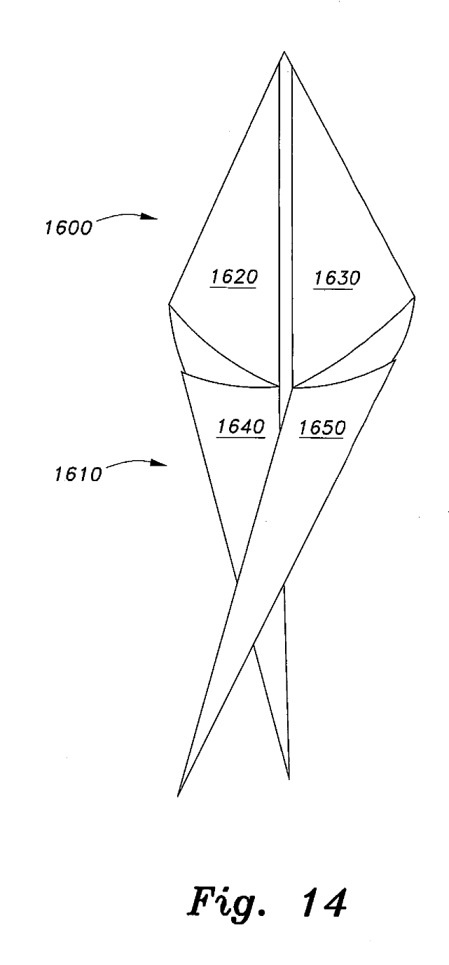

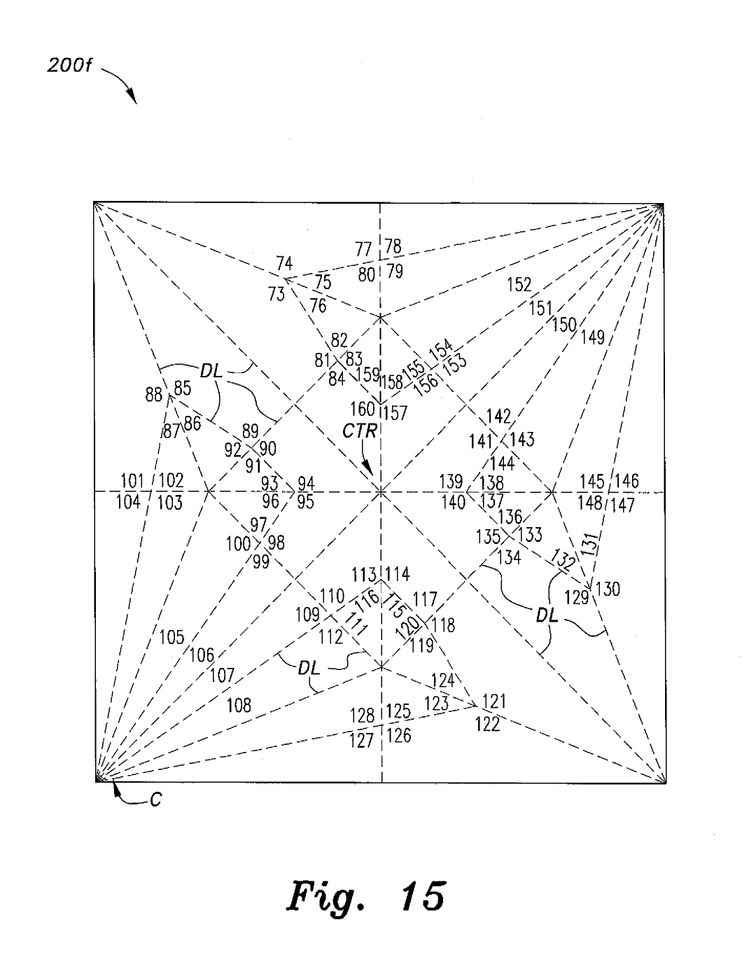

The seventh step in the series of steps in forming the origami crane includes folding the first outer edge 1116 of the fifth triangle 1115 and the second outer edge 1118 of the sixth triangle 1117 inward toward the middle M, as illustrated by the fifth arrows A5 to obtain the configuration shown in FIG. 13. The student repeats these folds on the opposite side of the ninth figure 500i to obtain the configuration shown in FIG. 14. The configuration shown in FIG. 14 has a second top portion 1600 including a ninth triangle 1620 and a tenth triangle 1630, and a second bottom portion 1610 including an eleventh triangle 1640 and a twelfth triangle 1650.

The student then unfolds the sheet of paper 100 having the configuration shown in FIG. 14 and numbers each of the additional new angles AN with the numbers 73 through 159 in numerical sequence to form the sixth intermediate stage 200f, as illustrated in FIG. 15. Once each new angle AN has been numbered with the numbers 73 through 159 the student(s) uses the numbers to create tables, such as Tables 1.73 through 1.59, to learn addition and subtraction, and other tables, such as Tables 2.73 through 2.160, to learn multiplication and division.

Tables 1.73 through 1.59 illustrate the addition operations and corresponding solutions and Tables 2.73 through 2.160 illustrate the multiplication operations and corresponding solutions using the numbers 73 through 159. The lowest sum is 74 (i.e., 73+1) and the highest sum is 160 (i.e., 159+1), whereas the lowest product is 73 (i.e., 73×1), and the highest product is 160 (i.e., 20×8). Subtraction is the reciprocal process of the addition operations illustrated in Tables 1.73 through 1.59, and division is the reciprocal process of the multiplication operations illustrated in Tables 2.73 through 2.160, respectively.

TABLE 1
Multiplication Table
Addition Tables (cont'd)

| Table 1.73 | Table 1.74 | Table 1.75 | Table 1.76 | Table 1.77 | Table 1.78 |
|---|---|---|---|---|---|
| 73 + 1 = 74 | 74 + 1 = 75 | 75 + 1 = 76 | 76 + 1 = 77 | 77 + 1 = 78 | 78 + 1 = 79 |
| 73 + 87 = 160 | 74 + 86 = 160 | 75 + 85 = 160 | 76 + 84 = 160 | 78 + 83 = 160 | 78 + 82 = 160 |
| Table 1.79 | Table 1.80 | Table 1.81 | Table 1.82 | Table 1.83 | Table 1.84 |
| 79 + 1 = 80 | 80 + 1 = 81 | 81 + 1 = 82 | 82 + 1 = 83 | 83 + 1 = 84 | 84 + 1 = 85 |
| 79 + 81 = 160 | 80 + 80 = 160 | 81 + 79 = 160 | 82 + 78 = 160 | 83 + 77 = 160 | 84 + 76 = 160 |
| Table 1.85 | Table 1.86 | Table 1.87 | Table 1.88 | Table 1.89 | Table 1.90 |
| 85 + 1 = 86 | 86 + 1 = 87 | 87 + 1 = 88 | 88 + 1 = 89 | 89 + 1 = 90 | 90 + 1 = 91 |
| 85 + 75 = 160 | 86 + 74 = 160 | 87 + 73 = 160 | 88 + 72 = 160 | 89 + 71 = 160 | 90 + 70 = 160 |
| Table 1.91 | Table 1.92 | Table 1.93 | Table 1.94 | Table 1.95 | Table 1.96 |
| 91 + 1 = 92 | 92 + 1 = 93 | 93 + 1 = 94 | 94 + 1 = 95 | 95 + 1 = 96 | 96 + 1 = 97 |
| 91 + 69 = 160 | 92 + 68 = 160 | 93 + 67 = 160 | 94 + 66 = 160 | 95 + 65 = 160 | 96 + 64 = 160 |
| Table 1.97 | Table 1.98 | Table 1.99 | Table 1.100 | Table 1.101 | Table 1.102 |
| 97 + 1 = 98 | 98 + 1 = 99 | 99 + 1 = 100 | 100 + 1 = 101 | 101 + 1 = 102 | 102 + 1 = 103 |
| 97 + 63 = 160 | 98 + 62 = 160 | 99 + 61 = 160 | 100 + 60 = 160 | 101 + 59 = 160 | 102 + 58 = 160 |
| Table 1.103 | Table 1.104 | Table 1.105 | Table 1.106 | Table 1.107 | Table 1.108 |
| 103 + 1 = 104 | 104 + 1 = 105 | 105 + 1 = 106 | 106 + 1 = 107 | 107 + 1 = 108 | 108 + 1 = 109 |
| 103 + 57 = 160 | 104 + 56 = 160 | 105 + 55 = 160 | 106 + 54 = 160 | 107 + 53 = 160 | 108 + 52 = 160 |
| Table 1.109 | Table 1.110 | Table 1.111 | Table 1.112 | Table 1.113 | Table 1.114 |
| 109 + 1 = 110 | 110 + 1 = 111 | 111 + 1 = 112 | 112 + 1 = 113 | 113 + 1 = 114 | 114 + 1 = 115 |
| 109 + 51 = 160 | 110 + 50 = 160 | 111 + 49 = 160 | 112 + 48 = 160 | 113 + 47 = 160 | 114 + 46 = 160 |
| Table 1.115 | Table 1.116 | Table 1.117 | Table 1.118 | Table 1.119 | Table 1.120 |
| 115 + 1 = 116 | 116 + 1 = 117 | 117 + 1 = 118 | 118 + 1 = 119 | 119 + 1 = 120 | 120 + 1 = 121 |
| 115 + 45 = 160 | 116 + 44 = 160 | 117 + 43 = 160 | 118 + 42 = 160 | 119 + 41 = 160 | 120 + 40 = 160 |
| Table 1.121 | Table 1.122 | Table 1.123 | Table 1.124 | Table 1.125 | Table 1.126 |
| 121 + 1 = 122 | 122 + 1 = 123 | 123 + 1 = 124 | 124 + 1 = 125 | 125 + 1 = 126 | 126 + 1 = 127 |
| 121 + 39 = 160 | 122 + 38 = 160 | 123 + 37 = 160 | 124 + 36 = 160 | 125 + 35 = 160 | 126 + 34 = 160 |
| Table 1.127 | Table 1.128 | Table 1.129 | Table 1.130 | Table 1.131 | Table 1.132 |
| 127 + 1 = 128 | 128 + 1 = 129 | 129 + 1 = 130 | 130 + 1 = 131 | 131 + 1 = 132 | 132 + 1 = 133 |
| 127 + 33 = 160 | 128 + 32 = 160 | 129 + 31 = 160 | 130 + 30 = 160 | 131 + 29 = 160 | 132 + 28 = 160 |
| Table 1.133 | Table 1.134 | Table 1.135 | Table 1.136 | Table 1.137 | Table 1.138 |
| 133 + 1 = 134 | 134 + 1 = 135 | 135 + 1 = 136 | 136 + 1 = 137 | 137 + 1 = 138 | 138 + 1 = 139 |
| 133 + 27 = 160 | 134 + 26 = 160 | 135 + 25 = 160 | 136 + 24 = 160 | 137 + 23 = 160 | 138 + 22 = 160 |
| Table 1.139 | Table 1.140 | Table 1.141 | Table 1.142 | Table 1.143 | Table 1.144 |
| 139 + 1 = 140 | 140 + 1 = 141 | 141 + 1 = 142 | 142 + 1 = 143 | 143 + 1 = 144 | 144 + 1 = 145 |
| 139 + 21 = 160 | 140 + 20 = 160 | 141 + 19 = 160 | 142 + 18 = 160 | 143 + 17 = 160 | 144 + 18 = 160 |
| Table 1.145 | Table 1.146 | Table 1.147 | Table 1.148 | Table 1.149 | Table 1.150 |
| 145 + 1 = 146 | 146 + 1 = 147 | 147 + 1 = 148 | 148 + 1 = 149 | 149 + 1 = 150 | 150 + 1 = 151 |
| 145 + 15 = 160 | 146 + 14 = 160 | 147 + 13 = 160 | 148 + 12 = 160 | 149 + 11 = 160 | 150 + 10 = 160 |
| Table 1.151 | Table 1.152 | Table 1.153 | Table 1.154 | Table 1.155 | Table 1.156 |
| 151 + 1 = 152 | 152 + 1 = 93 | 153 + 1 = 154 | 154 + 1 = 155 | 155 + 1 = 156 | 156 + 1 = 157 |
| 151 + 9 = 160 | 152 + 8 = 160 | 153 + 7 = 160 | 154 + 6 = 160 | 155 + 5 = 160 | 156 + 4 = 160 |

| Table 1.157 | Table 1.158 | Table 1.159 |
|---|---|---|
| 157 + 1 = 158 | 158 + 1 = 159 | 159 + 1 = 160 |
| 157 + 3 = 160 | 158 + 2 = 160 | |

| Table | Table | Table | Table | Table | Table |
|---|---|---|---|---|---|
| 2.73 | 2.74 | 2.75 | 2.76 | 2.77 | 2.78 |
| 1 × 73 = 73 | 1 × 74 = 74 | 1 × 75 = 75 | 1 × 76 = 76 | 1 × 77 = 77 | 1 × 78 = 78 |
| | 2 × 37 = 74 | 5 × 15 = 75 | 3 × 38 = 76 | 11 × 7 = 77 | 2 × 39 = 78 |
| Table | Table | Table | Table | Table | Table |
| 2.79 | 2.80 | 2.81 | 2.82 | 2.83 | 2.84 |
| 1 × 79 = 79 | 1 × 80 = 80 | 1 × 81 = 81 | 1 × 82 = 82 | 1 × 83 = 83 | 1 × 84 = 84 |
| | 2 × 40 = 80 | | 2 × 41 = 82 | | 2 × 42 = 84 |
| Table | Table | Table | Table | Table | Table |
| 2.85 | 2.86 | 2.87 | 2.88 | 2.89 | 2.90 |
| 1 × 85 = 85 | 1 × 86 = 86 | 1 × 87 = 87 | 1 × 88 = 88 | 1 × 89 = 89 | 1 × 90 = 90 |
| 5 × 17 = 85 | 2 × 43 = 86 | | 8 × 11 = 88 | | 2 × 45 = 90 |
| Table | Table | Table | Table | Table | Table |
| 2.91 | 2.92 | 2.93 | 2.94 | 2.95 | 2.96 |
| 1 × 91 = 91 | 1 × 92 × 92 | 1 × 93 = 93 | 1 × 94 = 94 | 1 × 95 = 95 | 1 × 96 = 96 |
| | 4 × 23 = 92 | 3 × 31 = 93 | 2 × 47 = 94 | 5 × 19 = 95 | 6 × 16 = 96 |
| Table | Table | Table | Table | Table | Table |
| 2.97 | 2.98 | 2.99 | 2.100 | 2.101 | 2.102 |
| 1 × 97 = 97 | 1 × 98 = 98 | 1 × 99 = 99 | 1 × 100 = 100 | 1 × 101 = 101 | 1 × 102 = 102 |
| | 2 × 49 = 98 | 9 × 11 = 99 | 10 × 10 = 100 | | 2 × 51 = 102 |
| Table | Table | Table | Table | Table | Table |
| 2.103 | 2.104 | 2.105 | 2.106 | 2.107 | 2.108 |
| 1 × 103 = 103 | 1 × 104 = 104 | 1 × 105 = 105 | 1 × 106 = 106 | 1 × 107 = 107 | 1 × 108 = 108 |
| | 8 × 13 = 104 | 5 × 21 = 105 | 2 × 53 = 106 | | 4 × 27 = 108 |
| Table | Table | Table | Table | Table | Table |
| 2.109 | 2.110 | 2.111 | 2.112 | 2.113 | 2.114 |
| 1 × 109 = 109 | 1 × 110 = 110 | 1 × 111 = 111 | 1 × 112 = 112 | 1 × 113 = 113 | 1 × 114 = 114 |
| | 11 × 10 = 110 | | 7 × 16 = 112 | | 2 × 57 = 114 |
| Table | Table | Table | Table | Table | Table |
| 2.115 | 2.116 | 2.117 | 2.118 | 2.119 | 2.120 |
| 1 × 115 = 115 | 1 × 116 = 116 | 1 × 117 = 117 | 1 × 118 = 118 | 1 × 119 = 119 | 1 × 120 = 120 |
| 5 × 23 = 115 | 4 × 29 = 116 | | 2 × 59 = 118 | | 10 × 12 = 120 |
| Table | Table | Table | Table | Table | Table |
| 2.121 | 2.122 | 2.123 | 2.124 | 2.125 | 2.126 |
| 1 × 121 = 121 | 1 × 121 = 122 | 1 × 123 = 123 | 1 × 124 = 124 | 1 × 125 = 125 | 1 × 126 = 126 |
| | 2 × 61 = 122 | | 4 × 31 = 124 | 2 × 25 = 125 | 2 × 63 = 126 |
| Table | Table | Table | Table | Table | Table |
| 2.127 | 2.128 | 2.129 | 2.130 | 2.131 | 2.132 |
| 1 × 127 = 127 | 1 × 128 = 128 | 1 × 129 = 129 | 1 × 130 = 130 | 1 × 131 = 131 | 1 × 132 = 132 |
| | 8 × 16 = 128 | 3 × 43 = 129 | 10 × 13 = 130 | | 11 × 12 = 132 |
| Table | Table | Table | Table | Table | Table |
| 2.133 | 2.134 | 2.135 | 2.136 | 2.137 | 2.138 |
| 1 × 133 = 133 | 1 × 134 = 134 | 1 × 135 = 135 | 1 × 136 = 136 | 1 × 137 = 137 | 1 × 138 = 138 |
| | 2 × 67 = 134 | 2 × 27 = 135 | 8 × 17 = 136 | | 6 × 23 = 138 |
| Table | Table | Table | Table | Table | Table |
| 2.139 | 2.140 | 2.141 | 2.142 | 2.143 | 2.144 |
| 1 × 139 = 139 | 1 × 140 = 140 | 1 × 141 = 141 | 1 × 142 = 142 | 1 × 143 = 143 | 1 × 144 = 144 |
| | 4 × 35 = 140 | | 2 × 71 = 142 | | 12 × 12 = 144 |
| Table | Table | Table | Table | Table | Table |
| 2.145 | 2.146 | 2.147 | 2.148 | 2.149 | 2.150 |
| 1 × 145 = 145 | 1 × 146 = 146 | 1 × 147 = 147 | 1 × 148 = 148 | 1 × 149 = 149 | 1 × 150 = 150 |
| | 2 × 73 = 146 | | 4 × 27 = 148 | | 10 × 15 = 150 |
| Table | Table | Table | Table | Table | Table |
| 2.151 | 2.152 | 2.153 | 2.154 | 2.155 | 2.156 |
| 1 × 151 = 151 | 1 × 152 = 152 | 1 × 153 = 153 | 1 × 154 = 154 | 1 × 155 = 155 | 1 × 156 = 156 |
| | 8 × 19 = 152 | | 2 × 77 = 154 | 5 × 31 = 155 | 2 × 78 = 156 |

| Table 2.157 | Table 2.158 | Table 2.159 | Table 2.160 |
|---|---|---|---|
| 1 × 157 = 157 | 1 × 158 = 158 | 1 × 159 = 159 | 1 × 160 = 160 |
| | 2 × 79 = 158 | 3 × 53 = 159 | 20 × 8 = 160 |

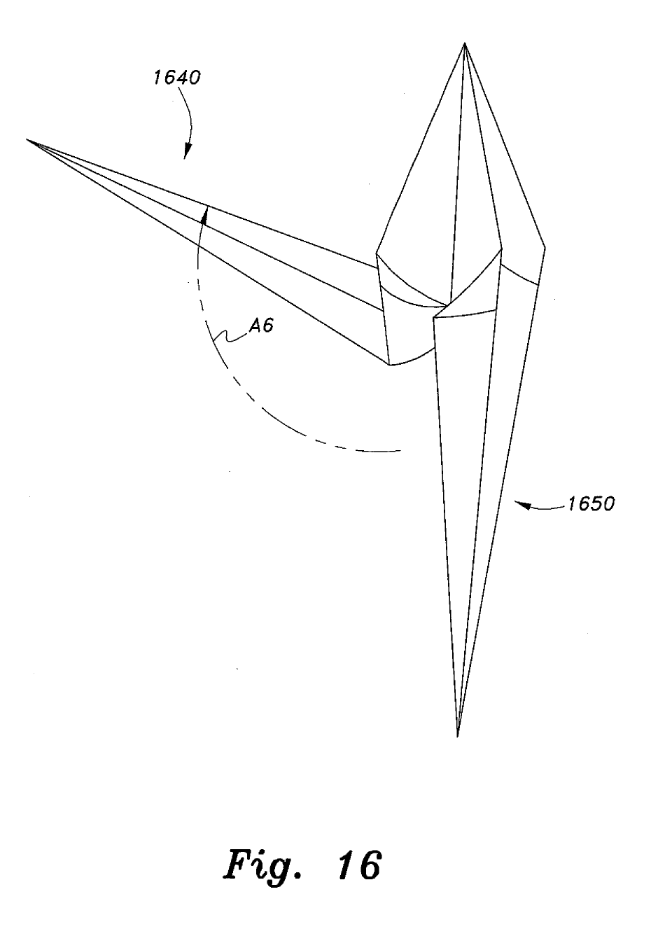

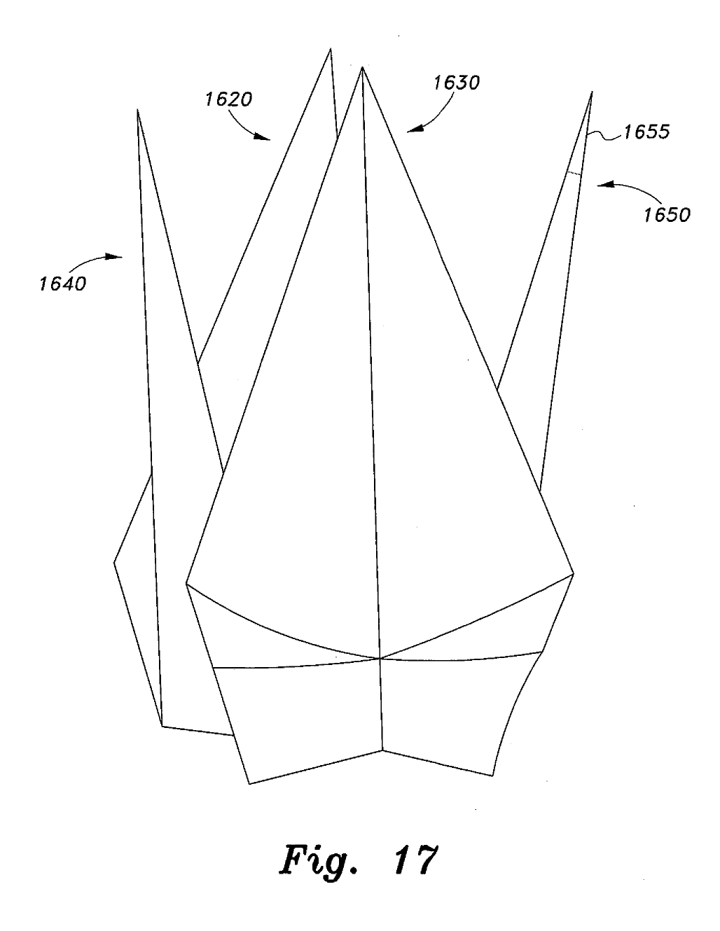

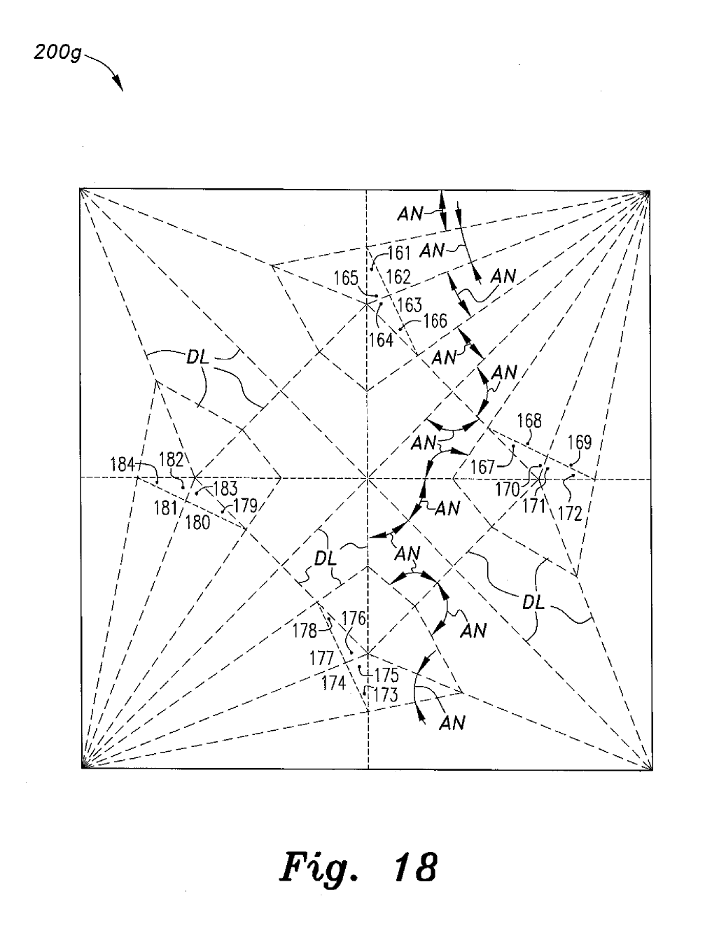

The eighth step in the series of steps in forming the origami crane includes folding the eleventh triangle 1640 on the second bottom portion 1610 of the configuration shown in FIG. 14 in an upward direction, as illustrated by the sixth arrow A6 (shown in FIG. 16). It is to be noted that the twelfth triangle 1650 on the second bottom portion 1610 of the configuration shown in FIG. 14 is also be folded in an upward direction in a similar fashion to form the configuration shown in FIG. 17. It is to be noted that the twelfth triangle 1650 has a head portion 1655.

The student then unfolds the configuration shown in FIG. 17 and numbers each of the additional new angles AN with the numbers 161 through 183 in numerical sequence to form the seventh intermediate stage 200g, as illustrated in FIG. 18. Once each new angle AN has been numbered with the numbers 161 through 183 the student(s) uses the numbers to create tables, such as Tables 1.161 through 1.183, to learn addition and subtraction, and other tables, such as Tables 2.164 through 2.184, to learn multiplication and division.

Tables 1.161 through 1.183 illustrate the addition operations and corresponding solutions and Tables 2.164 through 2.184 illustrate the multiplication operations and corresponding solutions using the numbers 161 through 183. The lowest sum is 161 (i.e., 160+1=161) and the highest sum is 184 (i.e., 183+1=184), whereas the lowest product is 161 (i.e., 161×1=161) and the highest product is 184 (i.e., 8×23=184). Subtraction is the reciprocal process of the addition operations illustrated in Tables 1.161 through 1.183, and division is the reciprocal process of the multiplication operations illustrated in Tables 2.164 through 2.184, respectively.

Addition Tables (cont'd)

| Table 1.161 | Table 1.162 | Table 1.163 | Table 1.164 | Table 1.165 | Table 1.166 |
|---|---|---|---|---|---|
| 160 + 1 = 161 | 161 + 1 = 162 | 163 + 1 = 164 | 164 + 1 = 165 | 165 + 1 = 166 | 166 + 1 = 167 |
| 161 + 23 = 184 | 162 + 22 = 184 | 163 + 21 = 184 | 164 + 20 = 184 | 165 + 19 = 184 | 166 + 18 = 184 |
| Table 1.167 | Table 1.168 | Table 1.169 | Table 1.170 | Table 1.171 | Table 1.172 |
| 167 + 1 = 168 | 168 + 1 = 169 | 169 + 1 = 170 | 170 + 1 = 171 | 171 + 1 = 172 | 172 + 1 = 173 |
| 167 + 17 = 184 | 168 + 16 = 184 | 169 + 15 = 184 | 170 + 14 = 184 | 171 + 13 = 184 | 172 + 12 = 184 |
| Table 1.173 | Table 1.174 | Table 1.175 | Table 1.176 | Table 1.177 | Table 1.178 |
| 172 + 1 = 174 | 174 + 1 = 175 | 175 + 1 = 176 | 176 + 1 = 177 | 177 + 1 = 178 | 178 + 1 = 179 |
| 173 + 11 = 184 | 174 + 10 = 184 | 175 + 9 = 184 | 176 + 8 = 184 | 177 + 7 = 184 | 178 + 6 = 184 |

| Table 1.179 | Table 1.180 | Table 1.181 | Table 1.182 | Table 1.183 |
|---|---|---|---|---|
| 179 + 1 = 180 | 180 + 1 = 181 | 181 + 1 = 182 | 182 + 1 = 183 | 183 + 1 = 184 |
| 179 + 5 = 184 | 180 + 4 = 184 | 181 + 3 = 184 | 182 + 2 = 184 | |

Multiplication Tables (cont'd)

| Table 2.164 | Table 2.165 | Table 2.166 | Table 2.167 | Table 2.168 | Table 2.169 |
|---|---|---|---|---|---|
| 1 × 164 = 164 | 1 × 165 = 165 | 1 × 166 = 166 | 1 × 167 = 167 | 1 × 168 = 168 | 1 × 169 = 169 |
| 4 × 41 = 164 | 11 × 15 = 165 | 2 × 83 = 166 | | 3 × 56 = 168 | |
| Table 2.170 | Table 2.171 | Table 2.172 | Table 2.173 | Table 2.174 | Table 2.175 |
| 1 × 170 = 170 | 1 × 171 = 171 | 1 × 172 = 172 | 1 × 173 = 173 | 1 × 174 = 174 | 1 × 175 = 175 |
| 5 × 34 = 170 | | 4 × 43 = 172 | | 2 × 87 = 174 | 7 × 25 = 175 |
| Table 2.176 | Table 2.177 | Table 2.178 | Table 2.179 | Table 2.180 | Table 2.181 |
| 1 × 173 = 176 | 1 × 177 = 177 | 1 × 178 = 178 | 1 × 179 = 179 | 1 × 180 = 180 | 1 × 181 = 181 |
| 16 × 11 = 176 | | 2 × 89 = 178 | | 12 × 15 = 180 | |

| Table 2.182 | Table 2.183 | Table 2.184 |
|---|---|---|
| 1 × 182 = 182 | 1 × 183 = 183 | 1 × 184 = 184 |
| 2 × 91 = 182 | 3 × 61 = 183 | 8 × 23 = 184 |

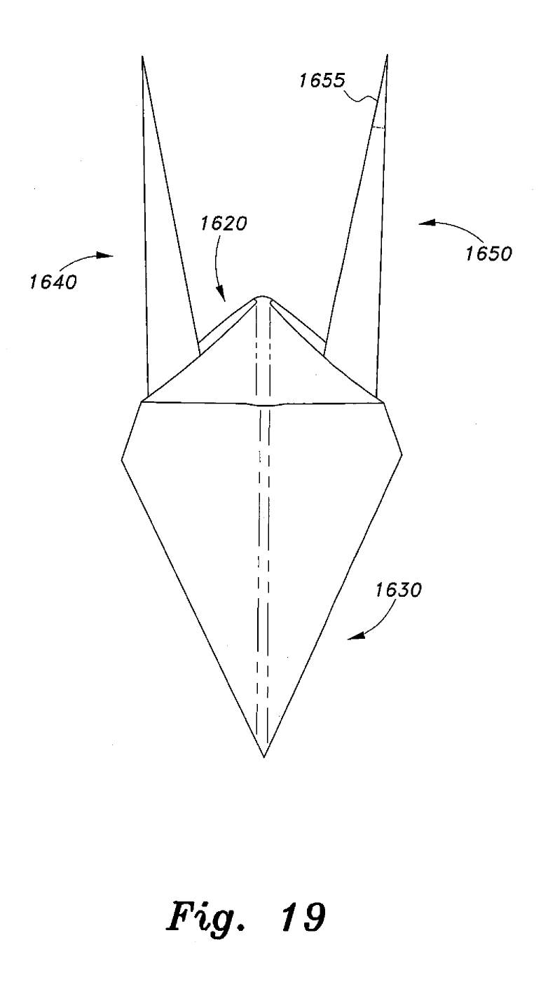

The ninth step in the series of steps in forming the origami crane includes folding in a downward direction the ninth triangle 1620 and the tenth triangle 1630 of the configuration shown in FIG. 17, as illustrated in FIG. 19, as well as folding the head portion 1655 of the twelfth triangle 1650 in a forward direction, as illustrated by the sixth arrow A6, to form the configuration shown in FIG. 20.

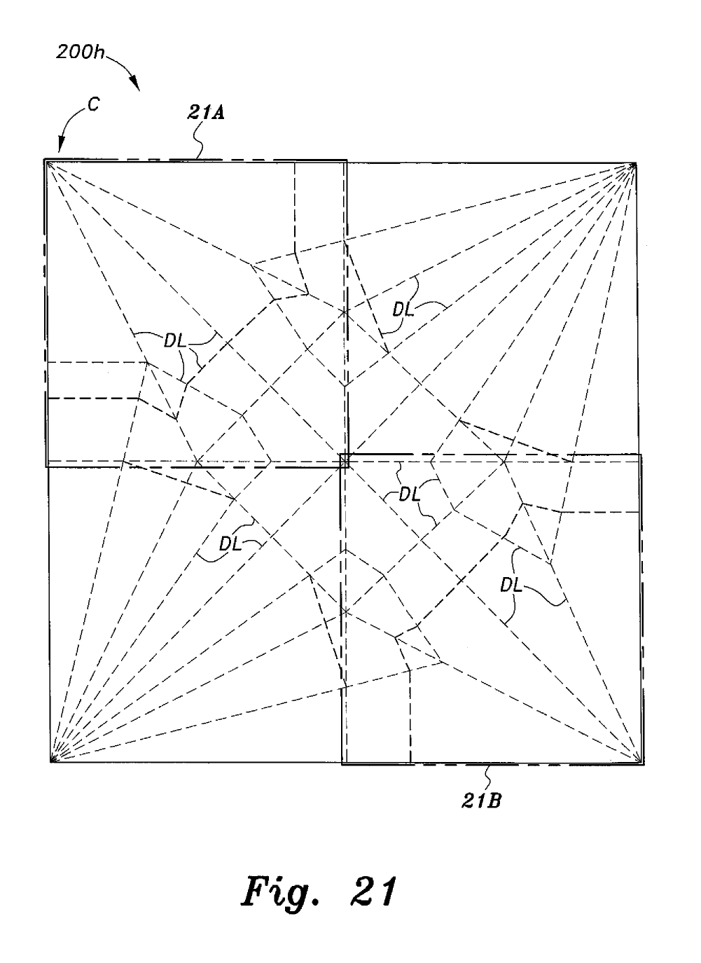

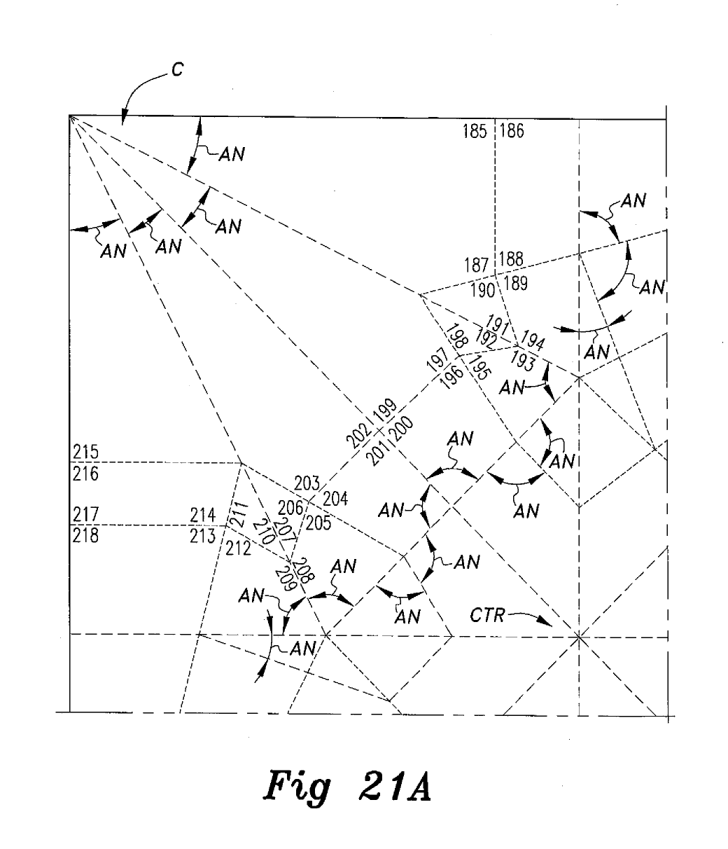

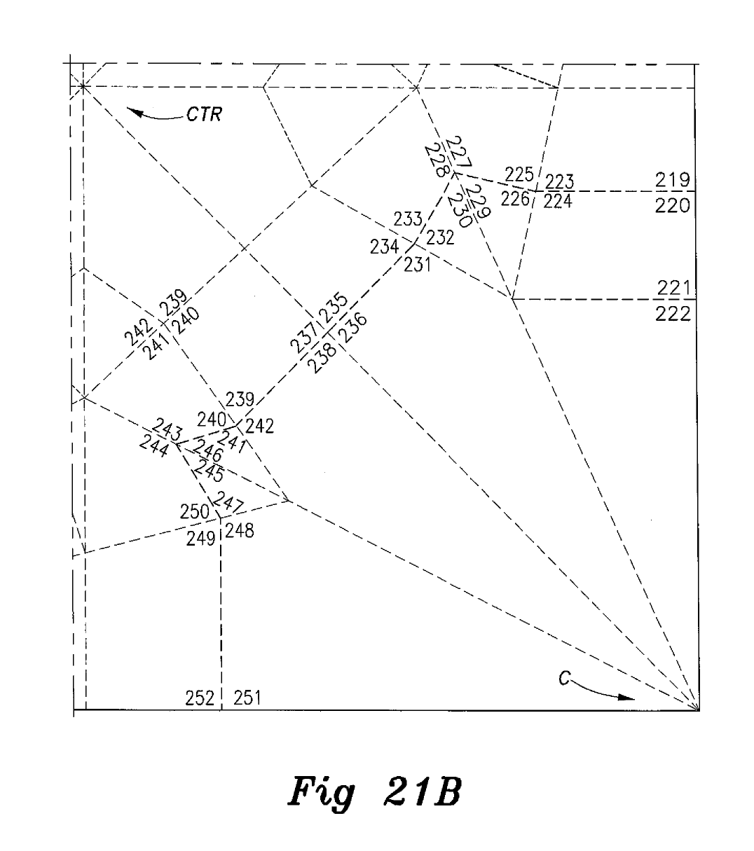

The student then unfolds the configuration shown in FIG. 20 and numbers each of the additional new angles AN with the numbers 185 through 251 in numerical sequence to form the eighth intermediate stage 200h, as illustrated in FIGS. 21, 21A, and 21B. Once each new angle AN has been numbered with the numbers 185 through 251, as illustrated in FIGS. 21A, and 21B, the student(s) uses the numbers to create tables, such as Tables 1.185 through 1.251, to learn addition and subtraction, and other tables, such as Tables 2.185 through 2.252, to learn multiplication and division.

Tables 1.185 through 1.251 illustrate the addition operations and corresponding solutions and Tables 2.185 through 2.252 illustrate the multiplication operations and corresponding solutions using the numbers 185 through 251. The lowest sum is 186 (i.e., 185+1=186) and the highest sum is 252 (i.e., 251+1=252), whereas the lowest product is 185 (i.e., 185×1=185) and the highest product is 252 (i.e., 14×18=252). Subtraction is the reciprocal process of the addition operations illustrated in Tables 1.185 through 1.251, and division is the reciprocal process of the multiplication operations illustrated in Tables 2.185 through 2.252, respectively.

Addition Tables (cont'd)

| Table 1.185 | Table 1.186 | Table 1.187 | Table 1.188 | Table 1.189 | Table 1.190 |
|---|---|---|---|---|---|
| 185 + 1 = 186 | 186 + 1 = 187 | 187 + 1 = 188 | 188 + 1 = 189 | 189 + 1 = 190 | 190 + 1 = 191 |
| 185 + 67 = 252 | 186 + 66 = 252 | 187 + 65 = 252 | 188 + 64 = 252 | 189 + 63 = 252 | 190 + 62 = 252 |
| Table 1.191 | Table 1.192 | Table 1.193 | Table 1.194 | Table 1.195 | Table 1.196 |
| 191 + 1 = 192 | 192 + 1 = 193 | 193 + 1 = 194 | 194 + 1 = 195 | 195 + 1 = 196 | 196 + 1 = 197 |
| 191 + 61 = 252 | 192 + 60 = 252 | 193 + 59 = 252 | 194 + 58 = 252 | 195 + 57 = 252 | 196 + 56 = 252 |
| Table 1.197 | Table 1.198 | Table 1.199 | Table 1.200 | Table 1.201 | Table 1.202 |
| 197 + 1 = 198 | 198 + 1 = 199 | 199 + 1 = 200 | 200 + 1 = 201 | 201 + 1 = 202 | 202 + 1 = 203 |
| 197 + 55 = 252 | 198 + 54 = 252 | 199 + 53 = 252 | 200 + 52 = 252 | 201 + 51 = 252 | 202 + 50 = 252 |
| Table 1.203 | Table 1.204 | Table 1.205 | Table 1.206 | Table 1.207 | Table1.208 |
| 203 + 1 = 204 | 204 + 1 = 205 | 205 + 1 = 206 | 206 + 1 = 207 | 207 + 1 = 208 | 208 + 1 = 209 |
| 203 + 49 = 252 | 204 + 48 = 252 | 205 + 47 = 252 | 206 + 46 = 252 | 207 + 45 = 252 | 208 + 44 = 252 |
| Table 1.209 | Table 1.210 | Table 1.211 | Table 1.212 | Table 1.213 | Table 1.214 |
| 209 + 1 = 210 | 210 + 1 = 211 | 211 + 1 = 212 | 212 + 1 = 213 | 213 + 1 = 214 | 214 + 1 = 215 |
| 209 + 43 = 252 | 210 + 42 = 252 | 211 + 41 = 252 | 212 + 40 = 252 | 213 + 39 = 252 | 214 + 38 = 252 |
| Table 1.215 | Table 1.216 | Table 1.217 | Table 1.218 | Table 1.219 | Table 1.220 |
| 215 + 1 = 216 | 216 + 1 = 217 | 217 + 1 = 218 | 218 + 1 = 219 | 219 + 1 = 220 | 220 + 1 = 221 |
| 215 + 37 = 252 | 216 + 36 = 252 | 217 + 35 = 252 | 218 + 34 = 252 | 219 + 33 = 252 | 220 + 32 = 252 |
| Table 1.221 | Table 1.222 | Table 1.223 | Table 1.224 | Table 1.225 | Table 1.226 |
| 221 + 1 = 222 | 222 + 1 = 223 | 223 + 1 = 224 | 224 + 1 = 225 | 225 + 1 = 226 | 226 + 1 = 227 |
| 221 + 31 = 252 | 222 + 30 = 252 | 223 + 29 = 252 | 224 + 28 = 252 | 225 + 27 = 252 | 226 + 26 = 252 |
| Table 1.227 | Table 1.228 | Table 1.229 | Table 1.230 | Table 1.231 | Table 1.232 |
| 227 + 1 = 228 | 228 + 1 = 229 | 229 + 1 = 230 | 230 + 1 = 231 | 231 + 1 = 232 | 232 + 1 = 233 |
| 227 + 25 = 252 | 228 + 24 = 252 | 229 + 23 = 252 | 230 + 22 = 252 | 231 + 21 = 252 | 232 + 20 = 252 |
| Table 1.233 | Table 1.234 | Table1.235 | Table 1.236 | Table 1.237 | Table 1.238 |
| 233 + 1 = 234 | 234 + 1 = 235 | 235 + 1 = 236 | 236 + 1 = 237 | 237 + 1 = 238 | 238 + 1 = 239 |
| 233 + 19 = 252 | 234 + 18 = 252 | 235 + 17 = 252 | 236 + 16 = 252 | 237 + 15 = 252 | 238 + 14 = 252 |
| Table 1.239 | Table 1.240 | Table 1.241 | Table 1.242 | Table 1.243 | Table 1.244 |
| 239 + 1 = 240 | 240 + 1 = 241 | 241 + 1 = 242 | 242 + 1 = 243 | 243 + 1 = 244 | 244 + 1 = 245 |
| 239 + 13 = 252 | 240 + 12 = 252 | 241 + 11 = 252 | 242 + 10 = 252 | 243 + 9 = 252 | 244 + 8 = 252 |
| Table 1.245 | Table 1.246 | Table 1.247 | Table 1.248 | Table 1.249 | Table 1.250 |
| 245 + 1 = 246 | 246 + 1 = 247 | 247 + 1 = 248 | 248 + 1 = 249 | 249 + 1 = 250 | 250 + 1 = 251 |
| 245 + 7 = 252 | 246 + 6 = 252 | 247 + 5 = 252 | 248 + 4 = 252 | 249 + 3 = 252 | 251 + 2 = 252 |

Table 1.251
251 + 1 = 252

Multiplication Tables (cont'd)

| Table | Table | Table | Table | Table | Table |
|---|---|---|---|---|---|
| 2.185 | 2.186 | 2.187 | 2.188 | 2.189 | 2.190 |
| 1 × 185 = 185 | 1 × 186 = 186 | 1 × 187 = 187 | 1 × 188 = 188 | 1 × 189 = 189 | 1 × 190 = 190 |
| | 6 × 31 = 186 | | 2 × 94 = 188 | 9 × 21 = 189 | 10 × 19 = 190 |
| Table | Table | Table | Table | Table | Table |
| 2.191 | 2.192 | 2.193 | 2.194 | 2.195 | 2.196 |
| 1 × 191 = 191 | 1 × 192 = 192 | 1 × 193 = 193 | 1 × 194 = 194 | 1 × 195 = 195 | 1 × 196 = 196 |
| | 12 × 16 = 192 | | 2 × 97 = 194 | 3 × 65 = 195 | 14 × 14 = 196 |
| Table 2.197 | Table 2.198 | Table 2.199 | Table 2.200 | Table 2.201 | Table 2.202 |
| 1 × 197 = 197 | 1 × 198 = 198 | 1 × 199 = 199 | 1 × 200 = 200 | 1 × 201 = 201 | 1 × 202 = 202 |
| | 11 × 18 = 198 | | 5 × 40 = 200 | 3 × 67 = 201 | 2 × 101 = 202 |
| Table 2.203 | Table 2.204 | Table 2.205 | Table 2.206 | Table 2.207 | Table 2.208 |
| 1 × 203 = 203 | 1 × 204 = 204 | 1 × 205 = 205 | 1 × 206 = 206 | 1 × 207 = 207 | 1 × 208 = 208 |
| | 4 × 51 = 204 | 5 × 41 = 205 | 2 × 103 = 206 | | 8 × 26 = 208 |
| Table 2.209 | Table 2.210 | Table 2.211 | Table 2.212 | Table 2.213 | Table 2.214 |
| 1 × 209 = 209 | 1 × 210 = 210 | 1 × 211 = 211 | 1 × 212 = 212 | 1 × 213 = 213 | 1 × 214 = 214 |
| 11 × 19 = 209 | 14 × 15 = 210 | | 4 × 53 = 212 | 3 × 71 = 213 | 2 × 107 = 214 |
| Table 2.215 | Table 2.216 | Table 2.217 | Table 2.218 | Table 2.219 | Table 2.220 |
| 1 × 215 = 215 | 1 × 216 = 216 | 1 × 217 = 217 | 1 × 218 = 218 | 1 × 219 = 219 | 1 × 220 = 220 |
| 5 × 43 = 215 | 12 × 18 = 216 | | 2 × 109 = 218 | 3 × 73 = 219 | 11 × 20 = 220 |
| Table 2.221 | Table 2.222 | Table 2.223 | Table 2.224 | Table 2.225 | Table 2.226 |
| 1 × 221 = 221 | 1 × 222 = 222 | 1 × 223 = 223 | 1 × 224 = 224 | 1 × 225 = 225 | 1 × 226 = 226 |
| | 6 × 37 = 222 | | 7 × 32 = 224 | 15 × 15 = 225 | 2 × 113 = 226 |
| Table 2.227 | Table 2.228 | Table 2.229 | Table 2.230 | Table 2.231 | Table 2.232 |
| 1 × 227 = 227 | 1 × 228 = 228 | 1 × 229 = 229 | 1 × 230 = 230 | 1 × 231 = 231 | 1 × 232 = 232 |
| | 4 × 57 = 228 | | 10 × 23 = 230 | 11 × 21 = 231 | 8 × 29 = 232 |
| Table 2.233 | Table 2.234 | Table 2.235 | Table 2.236 | Table 2.237 | Table 2.238 |
| 1 × 233 = 233 | 1 × 234 = 234 | 1 × 235 = 235 | 1 × 236 = 236 | 1 × 237 = 237 | 1 × 238 = 238 |
| | 2 × 117 = 234 | | 4 × 59 = 236 | | 2 × 119 = 238 |
| Table 2.239 | Table 2.240 | Table 2.241 | Table 2.242 | Table 2.243 | Table 2.244 |
| 1 × 239 = 239 | 1 × 240 = 240 | 1 × 241 = 241 | 1 × 242 = 242 | 1 × 243 = 243 | 1 × 244 = 244 |
| | 15 × 16 = 240 | | | | 4 × 61 = 244 |
| Table 2.245 | Table 2.246 | Table 2.247 | Table 2.248 | Table 2.249 | Table 2.250 |
| 1 × 245 = 245 | 1 × 246 = 246 | 1 × 247 = 247 | 1 × 248 = 248 | 1 × 249 = 249 | 1 × 250 = 250 |
| 5 × 49 = 245 | 6 × 41 = 246 | | 8 × 31 = 248 | 3 × 83 = 249 | 10 × 25 = 250 |

| Table 2.251 | Table 2.252 |
|---|---|
| 1 × 251 = 251 | 1 × 252 = 252 |
| | 14 × 18 = 252 |

As a result of following the steps, the sheet of paper 100, when unfolded, has the configuration shown in FIG. 1, as expanded with the details shown in FIGS. 1A through 1D. The student has learned addition, subtraction, multiplication, and division for the set of integers from 1 through 252. In the process, the student has constructed an origami crane, which helps to make the process of learning arithmetic fun.

The origami crane was selected because it has the greatest number of angles (252) of any origami figure, but, as discussed above, any other suitable origami figure may be used.

It is to be understood that the present invention is not limited to the embodiments described above, but encompasses any and all embodiments within the scope of the following claims.

1. An educational method of teaching arithmetic, comprising the steps of:
numbering the corners of a square sheet of paper in numerical sequence;
preparing addition tables using only the numbers on the sheet of paper for the addends and sums;
performing subtraction as a reciprocal operation of addition;
preparing multiplication tables using only the numbers on the sheet of paper for the multiplicands and products;
performing division as a reciprocal operation of multiplication;
folding the sheet of paper in a series of steps to form an origami figure;
numbering each new angle formed in the sheet by fold lines by continuing the numerical sequence after each folding step in the series;
forming additional addition and multiplication tables after each folding step in the series to include new sums and products made possible by the step of numbering each new angle formed by the fold lines; and
continuing the folding steps and forming new tables until the origami figure is completed.

2. The educational method of teaching arithmetic according to claim 1, wherein the origami figure is a crane.
